(19) United States
(12) Patent Application Publication
(10) Pub. No.: US 2007/0277674 A1
(43) Pub. Date: Dec. 6, 2007

(54) Method And System Of Processing Exhaust Gas, And Method And Apparatus Of Separating Carbon Dioxide

(76) Inventors: Yoshio Hirano, Hiroshima (JP); Kenji Hikino, Hiroshima (JP); Mitsugu Kakutani, Hiroshima (JP); Yoshio Seiki, Hiroshima (JP); Susumu Tsuneoka, Nagasaki (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/591,525

(22) PCT Filed: Mar. 2, 2005
(86) PCT No.: PCT/JP05/03449

§ 371 Date: Jul. 18, 2007

(30) Foreign Application Priority Data
Mar. 2, 2004 (JP) 2004-057603
Mar. 2, 2004 (JP) 2004-057604
Mar. 26, 2004 (JP) 2004-091852
Mar. 26, 2004 (JP) 2004-091853

(51) Int. Cl. B01D 53/62; B01D 53/50; B01J 19/00; B01D 53/56

(52) U.S. Cl. 95/290; 422/291

(57) ABSTRACT

An exhaust gas processing method comprises making exhaust gas, exhausted from a coal burning boiler or an LNG burning boiler, flow through coolant to cool it to such a first temperature as to liquefy or solidify nitrogen oxides or sulfur oxides without solidifying carbon dioxide, thereby liquefying or solidifying nitrogen oxides or sulfur oxides as toxic gas components contained in the exhaust gas to separate them from the exhaust gas; removing moisture contained in the exhaust gas; and cooling the exhaust gas to such a second temperature as to solidify carbon dioxide, thereby solidifying carbon dioxide contained in the exhaust gas to separate it from the exhaust gas.

### TECHNICAL FIELD

The present invention relates to a method and system of processing exhaust gas.

### BACKGROUND ART

Toxic gas components such as sulfur oxides and nitrogen oxides contained in exhaust gas exhausted from coal burning boilers of generating stations, chemical plants, etc., and blast furnaces, coke ovens, converters, etc., of ironworks are separated and removed with use of, for example, wet desulfurization apparatuses or denitrification apparatuses using a denitrification catalyst. Further, a so-called physical absorption method using activated carbon is known as a more efficient method of separating and removing toxic gas components.

Meanwhile, in recent years, the amount of carbon dioxide in the atmosphere has increased, and thus a relationship with the increase in atmospheric temperature called the greenhouse effect is becoming an issue. The increase in the amount of generated carbon dioxide is mostly caused by burning fossil fuel. Accordingly, generating stations, chemical plants, etc., are required to restrict the exhaust of carbon dioxide in exhaust gas into the atmosphere to be as little as possible from the environmental point of view. (Reference 1: Japanese Patent Application Laid-Open Publication No. 2000-317302.)

In such an environment, as to the processing of exhaust gas exhausted from, for example, coal burning boilers, and blast furnaces, coke ovens, converters, etc., of ironworks, carbon dioxide needs to be retrieved efficiently while toxic gas components such as nitrogen oxides and sulfur oxides are removed efficiently. Thus, an exhaust gas processing system is needed which can perform a sequence of the removal of toxic gas components and the retrieval of carbon dioxide efficiently and consecutively.

Furthermore, as to the processing of exhaust gas exhausted from, for example, LNG burning boilers, carbon dioxide needs to be retrieved efficiently while toxic gas components such as nitrogen oxides are removed efficiently. Thus, a scheme is needed which performs a sequence of the removal of toxic gas components and the retrieval of carbon dioxide efficiently and consecutively.

As to the processing of these exhaust gases, carbon dioxide needs to be retrieved efficiently while toxic gas components such as nitrogen oxides and sulfur oxides are removed efficiently. Thus, an exhaust gas processing system is needed which can perform a sequence of the removal of toxic gas components and the retrieval of carbon dioxide efficiently and consecutively.

Here, for the technology of the retrieval of carbon dioxide contained in the exhaust gas, technology of separating carbon dioxide from exhaust gas is important as elemental technology. For example, Reference 1 discloses as such technology, the technology wherein carbon dioxide in exhaust gas is solidified into dry ice and separated and then heated and pressured into liquid carbon dioxide. The method disclosed in the Reference can be carried out as indicated in, e.g., FIG. 11. In the method shown in the Figure, gas 1103 from which carbon dioxide is to be separated is made to flow inside heat transfer pipes 1102 of a heat exchanger having a coolant 1100 flow along their outside, thereby solidifying the carbon dioxide contained in the gas into dry ice and collecting it with a collecting container 1104. Dry ice 1105 collected in the collecting container 1104 is moved to a liquefying device 1106 and liquefied into liquid carbon dioxide 1107, which is retrieved. Note that the reason why the dry ice 1105 collected is liquefied is for convenience of storage and transport.

The method shown in FIG. 11 has dry ice precipitate on the insides of the heat transfer pipes 1102. Thus, the precipitated dry ice blocks the path in the heat transfer pipes 1102, thus making it difficult for this apparatus to operate continuously or automatically. Further, because the collecting container 1104 of the solidifying section, and the liquefying device 1106 as the liquefying section are separate devices respectively, a mechanism is needed which transfers the carbon dioxide from the collecting container 1104 to the liquefying device 1106. That is, with the method shown in FIG. 11, the process of separating carbon dioxide from the gas cannot be executed continuously and efficiently, and the method is not necessarily sufficient in performance if applied to, especially, sources generating a great amount of exhaust gas such as heat power stations and ironworks.

The present invention was made in view of the above background, and an object thereof is to provide an exhaust gas processing method and system which can remove toxic gas components and retrieve carbon dioxide efficiently from exhaust gas.

### MEANS FOR SOLVING THE PROBLEMS

According to claim 1 of the invention, there is provided an exhaust gas processing method comprising a first process of making exhaust gas flow through coolant to cool it to such a first temperature as to liquefy or solidify nitrogen oxides without solidifying carbon dioxide, thereby liquefying or solidifying nitrogen oxides as toxic gas components contained in the exhaust gas to separate them from the exhaust gas; and a second process of cooling the exhaust gas to such a second temperature as to solidify carbon dioxide, thereby solidifying carbon dioxide contained in the exhaust gas to separate it from the exhaust gas.

Here, the first temperature is a temperature at which carbon dioxide is not liquefied or solidified but moisture and nitrogen oxides are liquefied or solidified. The second temperature is a temperature at which carbon dioxide is solidified.

This method cools exhaust gas containing toxic gas components to such a first temperature as to liquefy or solidify nitrogen oxides without solidifying carbon dioxide, thereby liquefying or solidifying nitrogen oxides contained in the exhaust gas to separate them from the exhaust gas (the first process), and then cools the exhaust gas to such a second temperature as to solidify carbon dioxide, thereby solidifying carbon dioxide contained in the exhaust gas to separate it from the exhaust gas (the second process). In the first process, carbon dioxide remains in the exhaust gas without being separated from the exhaust gas, and subsequently in the second process, the carbon dioxide can be retrieved certainly. Thus, as to exhaust gas containing nitrogen oxides as toxic gas components, carbon dioxide can be efficiently retrieved with removing the toxic gas components.

According to claim 2 of the invention, there is provided the exhaust gas processing method according to claim 1, comprising a first process of making exhaust gas flow through coolant to cool it to such a first temperature as to liquefy or solidify nitrogen oxides and sulfur oxides without solidifying carbon dioxide, thereby liquefying or solidifying nitrogen oxides and sulfur oxides as toxic gas components contained in the exhaust gas to separate them from the exhaust gas; and a second process of cooling the exhaust gas to such a second temperature as to solidify carbon dioxide, thereby solidifying carbon dioxide contained in the exhaust gas to separate it from the exhaust gas.

Here, the first temperature is a temperature at which carbon dioxide is not liquefied or solidified but moisture, nitrogen oxides, and sulfur oxides are liquefied or solidified. The second temperature is a temperature at which carbon dioxide is solidified.

This method cools exhaust gas containing toxic gas components to such a first temperature as to liquefy or solidify nitrogen oxides and sulfur oxides without solidifying carbon dioxide, thereby liquefying or solidifying nitrogen oxides and sulfur oxides contained in the exhaust gas to separate them from the exhaust gas (the first process); and then cools the exhaust gas to such a second temperature as to solidify carbon dioxide, thereby solidifying carbon dioxide contained in the exhaust gas to separate it from the exhaust gas (the second process). In the first process, carbon dioxide remains in the exhaust gas without being separated from the exhaust gas, and subsequently in the second process, the carbon dioxide can be retrieved certainly. Thus, as to exhaust gas containing nitrogen oxides and sulfur oxides as toxic gas components, carbon dioxide can be efficiently retrieved with removing the toxic gas components.

According to claim 3 of the invention, there is provided the exhaust gas processing method according to claim 2, comprising a process of raising in temperature the toxic gas components separated from the exhaust gas by the first process to such a temperature as to vaporize the coolant but not the toxic gas components, thereby separating the toxic gas components and the coolant.

According to the invention, the coolant can be separated from the toxic gas components and retrieved reliably and thus, used effectively.

According to claim 4 of the invention, there is provided the exhaust gas processing method according to claim 3, comprising a process of circulating the coolant separated from the toxic gas components as the coolant through which the exhaust gas is made to flow.

Since the coolant is used circularly in this way, the coolant is used effectively.

According to claim 5 of the invention, there is provided the exhaust gas processing method according to any one of claims 2 to 4, comprising a process of raising in temperature the toxic gas components separated from the exhaust gas by the first process to such a temperature as to vaporize sulfur oxides but not nitrogen oxides, thereby separating the sulfur oxides and nitrogen oxides included in the toxic gas components.

As such, nitrogen oxides included in the toxic gas components can be separated from the exhaust gas, and thus sulfur oxides and nitrogen oxides included in the toxic gas components can be separated.

According to claim 6 of the invention, there is provided the exhaust gas processing method according to any one of claims 2 to 5, wherein the coolant includes any one of dimethyl ether, methanol, ethanol, toluene, and ethyl benzene.

The coolant is required to have the property of not solidifying at temperatures at which the toxic gas components are liquefied or solidified in order to separate the coolant from the toxic gas components liquefied or solidified in the first process. Further, to liquefy or solidify the toxic gas components efficiently with the coolant, the coolant is required to have the property of absorbing the toxic gas components easily. Yet further, to retrieve carbon dioxide from the exhaust gas efficiently in the second process, the coolant is required to have the property of hardly absorbing carbon dioxide. Any of the dimethyl ether, methanol, ethanol, toluene, and ethyl benzene meets this requirement.

According to claim 7 of the invention, there is provided the exhaust gas processing method according to any one of claims 2 to 6, wherein the first process includes a process of separating moisture contained in the exhaust gas from the exhaust gas.

In the first process, moisture contained in the exhaust gas is separated, and thus, carbon dioxide can be retrieved efficiently in the second process.

According to claim 8 of the invention, there is provided the exhaust gas processing method according to any one of claims 2 to 7, wherein the second process includes a process of liquefying the solidified carbon dioxide (dry ice).

As such, by liquefying the solidified carbon dioxide (dry ice), carbon dioxide is improved in storability and transferability, and improved in handleability.

According to claim 9 of the invention, there is provided the exhaust gas processing method according to any one of claims 2 to 8, wherein a preprocess of removing moisture, toxic gas components, and dust contained in the exhaust gas through heat exchange with water after the exhaust gas is cooled to about room temperature is executed before the first process.

By executing this preprocess, moisture, toxic gas components, and dust can be removed reliably from exhaust gas.

According to claim 10 of the invention, there is provided an exhaust gas processing system comprising a first apparatus which performs a process of making exhaust gas flow through coolant to cool it to such a first temperature as to liquefy or solidify nitrogen oxides without solidifying carbon dioxide, thereby liquefying or solidifying nitrogen oxides as toxic gas components contained in the exhaust gas to separate them from the exhaust gas; and a second apparatus which performs a process of cooling the exhaust gas to such a second temperature as to solidify carbon dioxide, thereby solidifying carbon dioxide contained in the exhaust gas to separate it from the exhaust gas.

According to claim 11 of the invention, there is provided the exhaust gas processing system according to claim 10, comprising a first apparatus which performs a process of making exhaust gas flow through coolant to cool it to such a first temperature as to liquefy or solidify nitrogen oxides and sulfur oxides without solidifying carbon dioxide, thereby liquefying or solidifying nitrogen oxides and sulfur oxides as toxic gas components contained in the exhaust gas to separate them from the exhaust gas; and a second apparatus which performs a process of cooling the exhaust gas to such a second temperature as to solidify carbon dioxide, thereby solidifying carbon dioxide contained in the exhaust gas to separate it from the exhaust gas.

According to claim 12 of the invention, there is provided the exhaust gas processing system according to claim 11, comprising an apparatus which raises in temperature the toxic gas components separated from the exhaust gas by the first apparatus to such a temperature as to vaporize the coolant, which is mixed with the toxic gas components, but not the toxic gas components, thereby separating the toxic gas components and the coolant.

According to claim 13 of the invention, there is provided the exhaust gas processing system according to claim 11, comprising an apparatus which circulates the coolant separated from the toxic gas components as the coolant through which the exhaust gas is made to flow.

According to claim 14 of the invention, there is provided the exhaust gas processing system according to any one of claims 11 to 13, comprising an apparatus which raises in temperature the toxic gas components separated from the exhaust gas by the first apparatus to such a temperature as to vaporize sulfur oxides but not nitrogen oxides, thereby separating the sulfur oxides and nitrogen oxides included in the toxic gas components.

According to claim 15 of the invention, there is provided the exhaust gas processing system according to any one of claims 11 to 14, wherein the coolant includes any one of dimethyl ether, methanol, ethanol, toluene, and ethyl benzene.

According to claim 16 of the invention, there is provided the exhaust gas processing system according to any one of claims 11 to 15, wherein the first apparatus comprises an apparatus which separates moisture contained in the exhaust gas from the exhaust gas.

According to claim 17 of the invention, there is provided the exhaust gas processing system according to any one of claims 11 to 16, wherein the second apparatus comprises an apparatus which liquefies the solidified carbon dioxide (dry ice).

According to claim 18 of the invention, there is provided the exhaust gas processing system according to any one of claims 11 to 17, comprising an apparatus which performs a preprocess of removing moisture, toxic gas components, and dust contained in the exhaust gas through heat exchange with water after the exhaust gas is cooled to about room temperature, before the process to be performed by the first apparatus.

According to claim 19 of the invention, there is provided an exhaust gas processing method characterized by comprising a first process of making exhaust gas exhausted from an LNG burning boiler flow through coolant to cool it to such a first temperature as to liquefy or solidify nitrogen oxides without solidifying carbon dioxide, thereby liquefying or solidifying nitrogen oxides as toxic gas components contained in the exhaust gas to separate them from the exhaust gas; and a second process of cooling the exhaust gas to such a second temperature as to solidify carbon dioxide, thereby solidifying carbon dioxide contained in the exhaust gas to separate it from the exhaust gas.

This method cools exhaust gas exhausted from an LNG burning boiler to such a first temperature as to liquefy or solidify nitrogen oxides without solidifying carbon dioxide, thereby liquefying or solidifying nitrogen oxides to separate them from the exhaust gas (the first process); and then cools the exhaust gas to such a second temperature as to solidify carbon dioxide, thereby solidifying carbon dioxide contained in the exhaust gas to separate it from the exhaust gas. In the first process, carbon dioxide remains in the exhaust gas without being separated from the exhaust gas, and subsequently in the second process, the carbon dioxide can be retrieved certainly. Thus, as to exhaust gas containing toxic gas components such as nitrogen oxides, the toxic gas components and carbon dioxide can be efficiently retrieved.

According to claim 20 of the invention, there is provided the exhaust gas processing method according to claim 19, comprising a process of introducing the nitrogen oxides solidified by the first process into a solid-liquid separator, thus separating the nitrogen oxides and the coolant.

As such, the toxic gas components and the coolant mixed therewith can be separated.

According to claim 21 of the invention, there is provided the exhaust gas processing method according to claim 20, comprising a process of raising in temperature the liquid separated by the solid-liquid separator to such a temperature as to vaporize the coolant but not the toxic gas components, thereby separating the coolant.

According to the invention, since the coolant can be retrieved efficiently, the coolant is used effectively.

According to claim 22 of the invention, there is provided the exhaust gas processing method according to claim 21, comprising a process of circulating the coolant separated from the liquid as the coolant through which the exhaust gas is made to flow.

Since the coolant is used circularly in this way, the coolant is used effectively.

According to claim 23 of the invention, there is provided the exhaust gas processing method according to any one of claims 19 to 22, wherein the coolant includes any one of dimethyl ether, methanol, ethanol, toluene, and ethyl benzene.

The coolant is required to have the property of not solidifying at temperatures at which the toxic gas components are liquefied or solidified in order to separate the coolant from the toxic gas components liquefied or solidified in the first process. Further, to liquefy or solidify the toxic gas components efficiently, the coolant is required to have the property of absorbing the toxic gas components easily. Yet further, to retrieve carbon dioxide from the exhaust gas efficiently in the second process, the coolant is required to have the property of hardly absorbing carbon dioxide. Any of the dimethyl ether, methanol, ethanol, toluene, and ethyl benzene meets this requirement.

According to claim 24 of the invention, there is provided the exhaust gas processing method according to any one of claims 19 to 23, wherein the first process includes a process of separating moisture contained in the exhaust gas from the exhaust gas.

As such, in the first process, moisture contained in the exhaust gas is separated, and thus, carbon dioxide can be retrieved efficiently in the second process.

According to claim 25 of the invention, there is provided the exhaust gas processing method according to any one of claims 19 to 24, wherein the second process includes a process of liquefying the solidified carbon dioxide (dry ice).

As such, by liquefying the solidified carbon dioxide (dry ice), carbon dioxide is improved in storability and transferability, and improved in handleability.

According to claim 26 of the invention, there is provided the exhaust gas processing method according to any one of claims 19 to 25, wherein a preprocess of removing moisture and toxic gas components contained in the exhaust gas through heat exchange with water after the exhaust gas is cooled to about room temperature is executed before the first process.

By executing this preprocess, moisture and toxic gas components can be removed reliably from exhaust gas.

According to claim 27 of the invention, there is provided the exhaust gas processing method according to any one of claims 19 to 26, wherein the exhaust gas or the coolant of at least one of the first and second processes is cooled due to the heat of vaporization that is produced when LNG is used as gas fuel.

As such, by cooling the exhaust gas or the coolant of at least one of the first and second processes by use of the heat of vaporization that is produced when LNG is used as gas fuel, energy for cooling can be saved.

According to claim 28 of the invention, there is provided an exhaust gas processing system comprising a first apparatus which performs a process of making exhaust gas exhausted from an LNG burning boiler flow through coolant to cool it to such a first temperature as to liquidize or solidify nitrogen oxides without solidifying carbon dioxide, thereby liquidizing or solidifying nitrogen oxides as toxic gas components contained in the exhaust gas to separate them from the exhaust gas; and a second apparatus which performs a process of cooling the exhaust gas to such a second temperature as to solidify carbon dioxide, thereby solidifying carbon dioxide contained in the exhaust gas to separate it from the exhaust gas.

According to claim 29 of the invention, there is provided the exhaust gas processing system according to claim 28, comprising an apparatus which introduces the nitrogen oxides solidified by the first apparatus into a solid-liquid separator, thus separating the nitrogen oxides and the coolant.

According to claim 30 of the invention, there is provided the exhaust gas processing system according to claim 29, comprising an apparatus which raises in temperature the liquid separated by the solid-liquid separator to such a temperature as to vaporize the coolant but not the toxic gas components, thereby separating the coolant.

According to claim 31 of the invention, there is provided the exhaust gas processing system according to claim 30, comprising an apparatus which circulates the coolant separated from the liquid as the coolant through which the exhaust gas is made to flow.

According to claim 32 of the invention, there is provided the exhaust gas processing system according to any one of claims 28 to 31, wherein the coolant includes any one of dimethyl ether, methanol, ethanol, toluene, and ethyl benzene.

According to claim 33 of the invention, there is provided the exhaust gas processing system according to any one of claims 28 to 32, wherein the first apparatus comprises an apparatus which separates moisture contained in the exhaust gas from the exhaust gas.

According to claim 34 of the invention, there is provided the exhaust gas processing system according to any one of claims 28 to 33, characterized in that the second apparatus comprises an apparatus which liquefies the solidified carbon dioxide (dry ice).

According to claim 35 of the invention, there is provided the exhaust gas processing system according to any one of claims 28 to 34, comprising an apparatus which performs a preprocess of removing moisture and toxic gas components contained in the exhaust gas through heat exchange with water after the exhaust gas is cooled to about room temperature, before the process to be performed by the first apparatus.

According to claim 36 of the invention, there is provided the exhaust gas processing system according to any one of claims 28 to 35, wherein that the exhaust gas or the coolant in at least one of the first and second apparatuses is cooled due to the heat of vaporization that is produced when LNG is used as gas fuel.

According to claim 37 of the invention, there is provided an exhaust gas processing system comprising a first apparatus which makes exhaust gas flow through coolant to cool it to such a temperature as to liquefy or solidify nitrogen oxides and sulfur oxides without solidifying carbon dioxide, thereby liquefying or solidifying nitrogen oxides and sulfur oxides as toxic gas components contained in the exhaust gas to separate them from the exhaust gas; and a second apparatus which makes the exhaust gas having had the nitrogen oxides and sulfur oxides removed flow through a pressure-resistant container to cool and solidify carbon dioxide, closes the pressure-resistant container air-tightly, raises in temperature the solidified carbon dioxide to vaporize, liquefies the carbon dioxide by pressure increase due to the vaporization of the carbon dioxide in the pressure-resistant container, and discharges the liquefied carbon dioxide outside the pressure-resistant container.

As such, in this system, the first apparatus cools gas containing toxic gas components to such a temperature as to liquefy or solidify nitrogen oxides and sulfur oxides without solidifying carbon dioxide, thereby liquefying or solidifying nitrogen oxides and sulfur oxides as toxic gas components contained in the exhaust gas to separate them from the exhaust gas. Hence, in the first apparatus, carbon dioxide remains in the exhaust gas without being separated from the exhaust gas, and subsequently in the second apparatus, the carbon dioxide can be retrieved certainly. With the second apparatus, the carbon dioxide can be solidified and liquefied in the same pressure-resistant container. According to the exhaust gas processing system of the invention, carbon dioxide can be separated from exhaust gas by a simple apparatus, thus realizing a scheme of retrieving carbon dioxide from exhaust gas at low cost, efficiently, and reliably. Further, without using a special liquefying apparatus, carbon dioxide can be discharged in liquid, which is storable and transferable. Thus, the exhaust gas processing system of the invention can efficiently, reliably retrieve carbon dioxide from exhaust gas containing toxic gas components such as nitrogen oxides and sulfur oxides with removing the toxic gas components.

According to claim 38 of the invention, there is provided the exhaust gas processing system according to claim 37, comprising an apparatus which raises in temperature the toxic gas components separated from the exhaust gas by the first apparatus to such a temperature as to vaporize the coolant, which is mixed with the toxic gas components, but not the toxic gas components, thereby separating the toxic gas components and the coolant.

By this means, the coolant can be reliably separated from the toxic gas components and retrieved, and thus used effectively.

According to claim 39 of the invention, there is provided the exhaust gas processing system according to claim 37 or 38, comprising an apparatus which raises in temperature the toxic gas components separated from the exhaust gas by the first apparatus to such a temperature as to vaporize sulfur oxides but not nitrogen oxides, thereby separating the sulfur oxides and nitrogen oxides included in the toxic gas components.

By this means, nitrogen oxides included in the toxic gas components can be separated from the exhaust gas, and the sulfur oxides and nitrogen oxides included in the toxic gas components can be separated.

According to claim 40 of the invention, there is provided an exhaust gas processing system comprising a first apparatus which performs a process of making exhaust gas exhausted from an LNG burning boiler flow through coolant to cool it to such a first temperature as to liquefy or solidify nitrogen oxides without solidifying carbon dioxide, thereby liquefying or solidifying nitrogen oxides as toxic gas components contained in the exhaust gas to separate them from the exhaust gas; and a second apparatus which makes the exhaust gas having had the nitrogen oxides removed flow through a pressure-resistant container to cool and solidify carbon dioxide, closes the pressure-resistant container air-tightly, raises in temperature the solidified carbon dioxide to vaporize, liquefies the carbon dioxide by pressure increase due to the vaporization of the carbon dioxide in the pressure-resistant container, and discharges the liquefied carbon dioxide outside the pressure-resistant container.

In this system, the first apparatus cools gas exhausted from an LNG burning boiler to such a first temperature as to liquefy or solidify nitrogen oxides without solidifying carbon dioxide, thereby liquefying or solidifying nitrogen oxides as toxic gas components contained in the exhaust gas to separate them from the exhaust gas. Hence, in the first apparatus, carbon dioxide remains in the exhaust gas without being separated from the exhaust gas, and subsequently in the second apparatus, the carbon dioxide can be retrieved certainly. With the second apparatus, the carbon dioxide can be solidified and liquefied in the same pressure-resistant container. According to the exhaust gas processing system of the invention, carbon dioxide can be separated from exhaust gas by a simple apparatus, thus realizing a scheme of retrieving carbon dioxide from exhaust gas at low cost, efficiently, and reliably. Further, without using a special liquefying apparatus, carbon dioxide can be discharged in liquid, which is storable and transferable. Thus, the exhaust gas processing system of the invention can efficiently retrieve carbon dioxide from exhaust gas containing toxic gas components such as nitrogen oxides with removing the toxic gas components.

According to claim 41 of the invention, there is provided the exhaust gas processing system according to claim 40, comprising an apparatus which introduces the nitrogen oxides solidified by the first process into a solid-liquid separator, thus separating the nitrogen oxides and the coolant.

By this means, the toxic gas components and the coolant mixed therewith can be separated efficiently, reliably.

According to claim 42 of the invention, there is provided the exhaust gas processing system according to claim 41, comprising an apparatus which raises in temperature the liquid separated by the solid-liquid separator to such a temperature as to vaporize the coolant but not the toxic gas components, thereby separating the coolant.

By this means, the coolant can be efficiently retrieved, and thus used effectively.

According to claim 43 of the invention, there is provided the exhaust gas processing system according to any one of claims 37 to 42, characterized in that the coolant includes any one of dimethyl ether, methanol, ethanol, toluene, and ethyl benzene.

The coolant is required to have the property of not solidifying at temperatures at which the toxic gas components are liquefied or solidified in order to separate the coolant from the toxic gas components liquefied or solidified in the first process. Further, to liquefy or solidify the toxic gas components efficiently, the coolant is required to have the property of absorbing the toxic gas components easily. Yet further, to retrieve carbon dioxide from the exhaust gas efficiently in the second process, the coolant is required to have the property of hardly absorbing carbon dioxide. Any of the dimethyl ether, methanol, ethanol, toluene, and ethyl benzene meets this requirement.

According to claim 44 of the invention, there is provided the exhaust gas processing system according to any one of claims 37 to 43, wherein the cooling and solidifying of the carbon dioxide by the second apparatus is performed by causing gas containing the carbon dioxide to contact the outside of a coolant flow pipe provided in the pressure-resistant container through which coolant flows.

Thus, dry ice precipitates on the outside of the coolant flow pipe, and the inside path of the heat transfer pipe will not be blocked. Hence, it is easy to carry out continuous or automatic operation.

According to claim 45 of the invention, there is provided the exhaust gas processing system according to any one of claims 37 to 44, wherein the coolant flow pipe is arranged to be serpentine.

As such, arranging the coolant flow pipe to be serpentine secures enough area of contact between gas and the coolant flow pipe, thus solidifying the carbon dioxide efficiently.

According to claim 46 of the invention, there is provided a method of separating carbon dioxide, comprising making gas containing carbon dioxide flow through a pressure-resistant container to cool and solidify the carbon dioxide; closing the pressure-resistant container air-tightly; raising in temperature the solidified carbon dioxide to vaporize; liquefying the carbon dioxide by pressure increase due to the vaporization of the carbon dioxide in the pressure-resistant container; and discharging the liquefied carbon dioxide outside the pressure-resistant container.

According to the invention, carbon dioxide can be solidified and liquefied in the same pressure-resistant container. The above method can be implemented by a simple apparatus, and carbon dioxide can be separated from gas at low cost, efficiently, and reliably. Further, without using a special liquefying apparatus, carbon dioxide can be discharged in liquid, which is storable and transferable.

According to claim 47 of the invention, there is provided the method of separating carbon dioxide according to claim 46, wherein the cooling and solidifying is performed by causing gas containing the carbon dioxide to contact the outside of a coolant flow pipe provided in the pressure-resistant container through which coolant flows.

According to the invention, dry ice precipitates on the outside of the coolant flow pipe, and the inside path of the heat transfer pipe will not be blocked. Hence, it is easy to carry out continuous or automatic operation.

According to claim 48 of the invention, there is provided the method of separating carbon dioxide according to claim 47, wherein the coolant flow pipe is arranged to be serpentine.

As such, arranging the coolant flow pipe to be serpentine secures enough area of contact between gas and the coolant flow pipe, thus solidifying the carbon dioxide efficiently.

According to claim 49 of the invention, there is provided the method of separating carbon dioxide according to claim 46, wherein the raising in temperature of the solidified carbon dioxide is performed by a heat transfer pipe or an electric heater provided in the pressure-resistant container.

According to claim 50 of the invention, there is provided the method of separating carbon dioxide according to claim 46, wherein the pressure-resistant container has a gas inlet which lets gas containing the carbon dioxide flow into the pressure-resistant container; a gas outlet through which gas in the pressure-resistant container is discharged outside the pressure-resistant container; and a liquid outlet through which the liquefied carbon dioxide is discharged outside the pressure-resistant container.

According to claim 51 of the invention, there is provided the method of separating carbon dioxide according to claim 46 or 47, wherein the gas includes nitrogen oxides or sulfur oxides.

According to claim 52 of the invention, there is provided a method of separating carbon dioxide which uses a pressure-resistant container having a gas inlet to let gas flow into it, a gas outlet to let gas therein be discharged, and a liquid outlet to let liquid therein be discharged; a cooler provided in the pressure-resistant container; and a heat transfer device to raise in temperature the inside of the pressure-resistant container, comprising letting gas containing carbon dioxide flow into the pressure-resistant container through the gas inlet; causing the gas to contact the cooler, thereby cooling and solidifying the carbon dioxide; closing the gas inlet and gas outlet, thereby closing the pressure-resistant container air-tightly; raising in temperature the solidified carbon dioxide to vaporize with use of the heat transfer device; liquefying the carbon dioxide by pressure increase due to the vaporization of the carbon dioxide in the pressure-resistant container; and discharging the liquefied carbon dioxide outside the pressure-resistant container through the liquid outlet.

According to claim 53 of the invention, there is provided an apparatus of separating carbon dioxide comprising a pressure-resistant container having a gas inlet to let gas flow into it, a gas outlet to let gas therein be discharged, a liquid outlet to let liquid therein be discharged, a control valve to control the amount of gas flowing in through the gas inlet, a control valve to control the amount of gas being discharged through the gas outlet, and a control valve to control the amount of liquid being discharged through the liquid outlet; a cooler provided in the pressure-resistant container; and a heat transfer device that raises in temperature the inside of the pressure-resistant container.

### BRIEF DESCRIPTION OF THE DRAWINGS

FIG. 1 shows schematically the configuration of an exhaust gas processing system according to an embodiment of the present invention;

FIG. 2A shows results of measuring change in the concentration of sulfur dioxide in the model gas when model gas having sulfur dioxide in a concentration of 80 ppm is made to flow through DME according to the embodiment of the present invention;

FIG. 2B shows the configuration of an apparatus used in measuring the amounts of sulfur dioxide and nitrogen monoxide dissolving in coolant according to the embodiment of the present invention;

FIG. 2C shows the composition of the model exhaust gas according to the embodiment of the present invention;

FIG. 2D shows results of measuring the amounts of sulfur dioxide and nitrogen monoxide dissolving in coolant according to the embodiment of the present invention;

FIG. 2E shows the configuration of a dry ice sublimator 24 used in measuring the retrieval rate of carbon dioxide against the temperature of model gas according to the embodiment of the present invention;

FIG. 2F is a side view of the dry ice sublimator 24 as seen in the direction indicated by an arrow A in FIG. 2E according to the embodiment of the present invention;

FIG. 2G shows results of measuring the retrieval rate of carbon dioxide against the temperature of model gas according to the embodiment of the present invention;

FIG. 3 shows schematically the configuration of an exhaust gas processing system according to an embodiment of the present invention;

FIG. 4A shows results of measuring change in the concentration of sulfur dioxide in the model gas when model gas having sulfur dioxide in a concentration of 80 ppm is made to flow through DME according to the embodiment of the present invention;

FIG. 4B shows the configuration of an apparatus used in measuring the amounts of sulfur dioxide and nitrogen monoxide dissolving in coolant according to the embodiment of the present invention;

FIG. 4C shows the composition of the model exhaust gas according to the embodiment of the present invention;

FIG. 4D shows results of measuring the amounts of sulfur dioxide and nitrogen monoxide dissolving in coolant according to the embodiment of the present invention;

FIG. 4E shows the configuration of a dry ice sublimator 24 used in measuring the retrieval rate of carbon dioxide against the temperature of model gas according to the embodiment of the present invention;

FIG. 4F is a side view of the dry ice sublimator 24 as seen in the direction indicated by an arrow A in FIG. 2E according to the embodiment of the present invention;

FIG. 4G shows results of measuring the retrieval rate of carbon dioxide against the temperature of model gas according to the embodiment of the present invention;

FIG. 5 shows schematically the configuration of an exhaust gas processing system according to an embodiment of the present invention;

FIG. 6 shows results of measuring change in the concentration of sulfur dioxide in the model gas when model gas having sulfur dioxide in a concentration of 80 ppm is made to flow through DME according to the embodiment of the present invention;

FIG. 7 shows schematically the configuration of a carbon dioxide separator 30 according to an embodiment of the present invention;

FIG. 8 shows the process flow of a process of separating carbon dioxide contained in exhaust gas by the carbon dioxide separator 30 according to the embodiment of the present invention;

FIG. 9 is a T-P (temperature-pressure) diagram for carbon dioxide;

FIG. 10 shows schematically the configuration of an exhaust gas processing system according to an embodiment of the present invention; and

FIG. 11 is a view explaining one technology for separating carbon dioxide.

### EXPLANATION OF REFERENCE NUMERALS

10 Exhaust gas source,
11 Heat exchanger,
13 Condenser,
14 Effluent cistern,
17 Dehydrating tower,
18 DME cooling tower,
20 DME separation tower,
22 Component separation tower,
23 Reversible heat exchanger,
24 Dry ice sublimator,
25 Cyclone,
26 Dry ice melting device,
27 Liquefied-carbonic acid storage,
28 Solid-liquid separator,
30 Carbon dioxide separator,
40 Refrigerator,
50 Effluent processing apparatus,
51 Smokestack

### BEST MODE FOR CARRYING OUT THE INVENTION

A preferred embodiment of an exhaust gas processing system according to the present invention will be described in detail below with reference to the accompanying drawings.

### First Embodiment

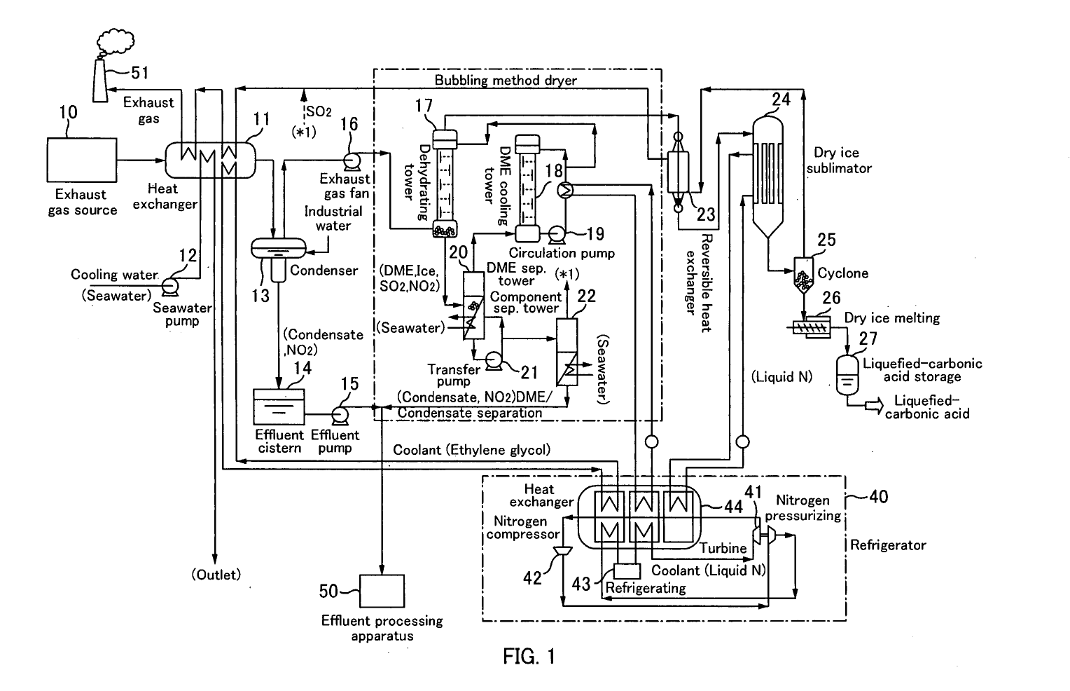

FIG. 1 shows the schematic configuration of an exhaust gas processing system according to a first embodiment of the present invention. The exhaust gas processing system of the present embodiment provides a scheme that efficiently removes moisture and toxic gas components from exhaust gas including the toxic gas components such as nitrogen oxides and sulfur oxides, exhausted from an exhaust gas source 10 such as a coal burning boiler or a heavy oil burning boiler of a generating station, chemical plant, etc., or a blast furnace, coke oven, or converter of an ironwork, and that efficiently retrieves carbon dioxide from the exhaust gas.

In the exhaust gas processing system of the present embodiment, in its preprocess, exhaust gas including toxic gas components such as nitrogen oxides and sulfur oxides, exhausted from the exhaust gas source 10 is introduced into industrial water contained in a heat exchanger 11 and a condenser 13 and thereby cooled to about room temperature. Then, in a first process, the exhaust gas cooled to about room temperature is cooled in a dehydrating tower 17 to such a first temperature as not to solidify carbon dioxide, and thereby moisture, nitrogen oxides, and sulfur oxides contained in the exhaust gas are liquefied or solidified and thus separated from the exhaust gas. Next, in a second process, the exhaust gas has moisture, nitrogen oxides, and sulfur oxides separated therefrom is cooled in a dry ice sublimator 24 to a second temperature lower than the first temperature, and thereby carbon dioxide contained in the exhaust gas is solidified and separated from the exhaust gas.

Although the toxic gas components separated in the first process are mixed with the coolant, the coolant is preferably circulated to use effectively in order to operate the exhaust gas processing system efficiently. Accordingly, in this embodiment, with use of an evaporation method using the difference in evaporation temperature between the coolant and the toxic gas components, the coolant is separated from the toxic gas components and retrieved, and the retrieved coolant is again used as coolant. Note that although the evaporation method needs energy for heating, the energy can be reduced by adopting a coolant having a low boiling point.

In order to retrieve carbon dioxide contained in the exhaust gas efficiently in the second process, the carbon dioxide needs to be not liquefied or solidified when moisture and the toxic gas components are liquefied or solidified. Carbon dioxide in heat power station exhaust gas solidifies into dry ice below a predetermined temperature. Hence, in order not to allow the carbon dioxide to solidify, gas temperature at the exit of the dehydrating tower 17 is made to be higher than the predetermined temperature.

In the first process, the coolant itself is required to have the property of not solidifying at temperatures at which the toxic gas components are liquefied or solidified in order to separate the coolant from the toxic gas components liquefied or solidified. Further, to liquefy or solidify the toxic gas components efficiently, the coolant is required to have the property of absorbing the toxic gas components easily. Yet further, to retrieve carbon dioxide from the exhaust gas efficiently in the second process, the coolant is required to have the property that carbon dioxide does not easily dissolve therein.

A specific coolant that satisfies these requirements is dimethyl ether (hereinafter, called DME). Other materials than dimethyl ether can be used as the coolant as long as they satisfy the requirements for the coolant. For example, inorganic salts (sodium chloride, potassium chloride, etc.), bromine compounds (lithium bromide, bromo bromide, etc.), ethers (dimethyl ether, methyl ether, etc.), alcohols (methanol, ethanol, etc.), silicon oils, paraffinic hydrocarbon (propane, butane, etc.), olefin-base hydrocarbon, and the like can be used as the coolant, which satisfy the requirements. Specifically, methanol, ethanol, toluene, ethyl benzene, and the like can be used as the coolant. In order to separate the toxic gas components liquefied or solidified from the coolant, the greater difference in boiling point between the coolant and the toxic gas components is more advantageous. From this point of view, ethers and alcohols are preferred as the coolant.

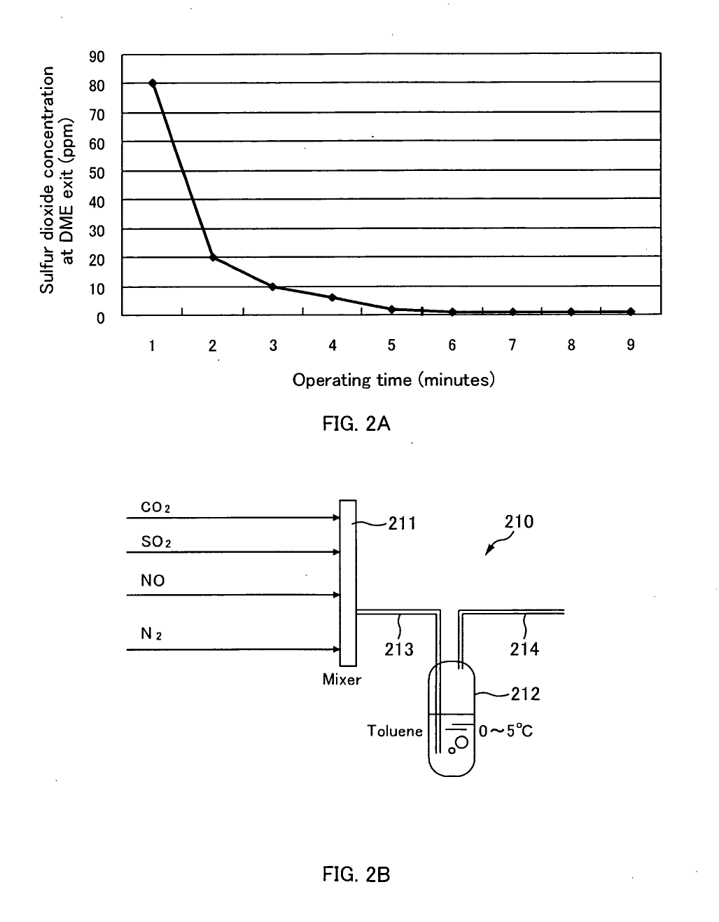

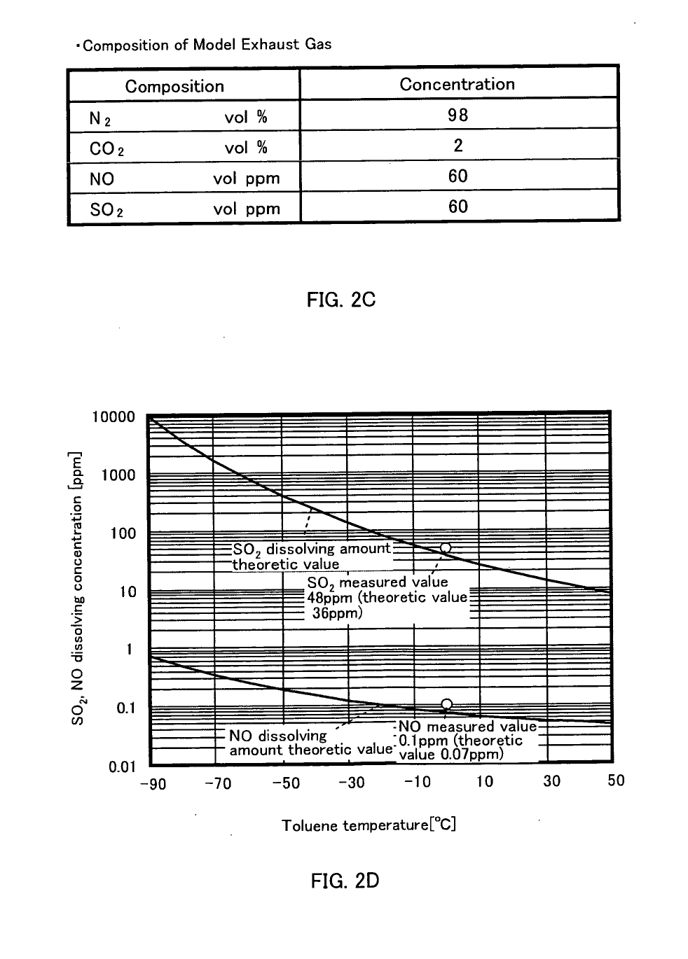

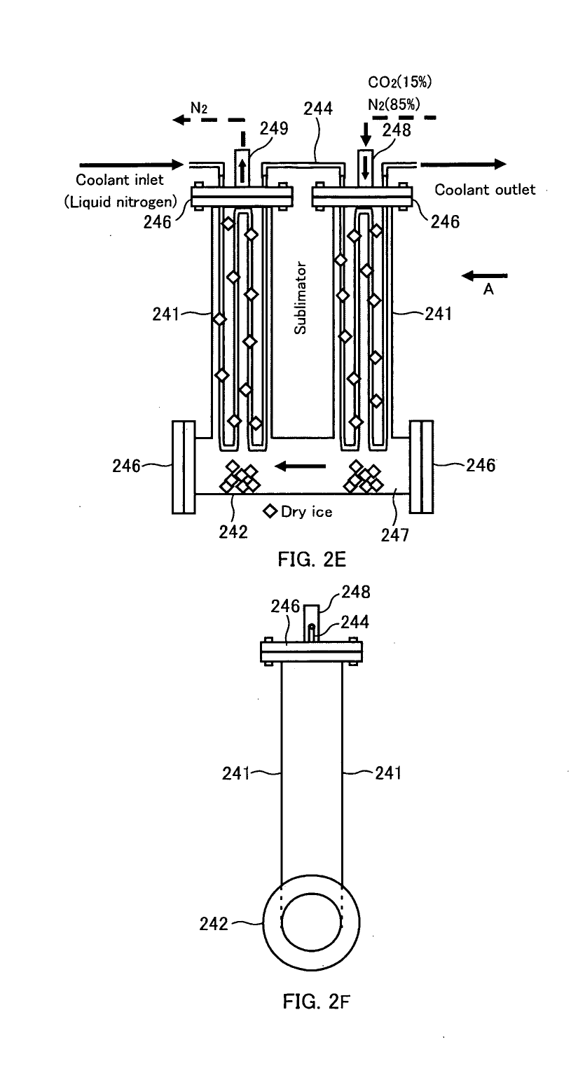

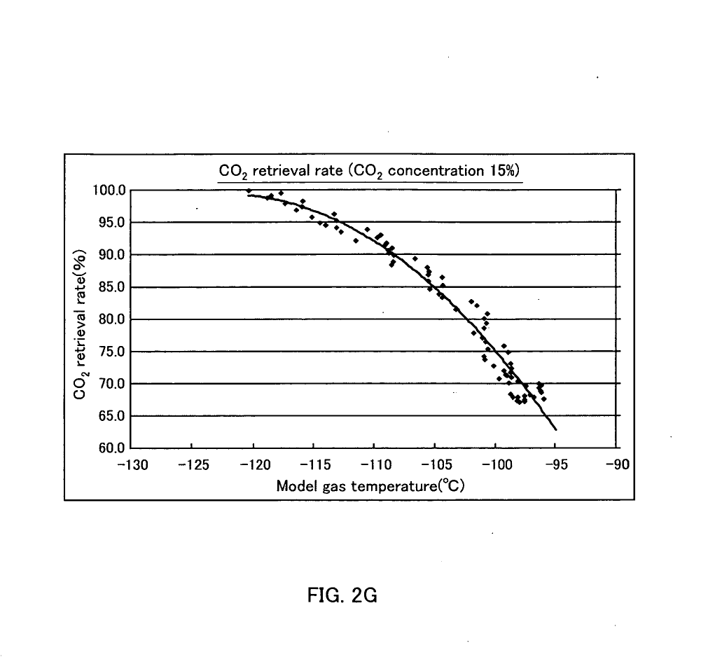

FIG. 2A shows results of measuring change in the concentration of carbon dioxide in the model gas when model gas having carbon dioxide in a concentration of 10% is made to flow through DME. As shown in the Figure, the concentration of carbon dioxide in the model gas decreases temporarily at the time when the model gas starts to flow through DME because the model gas dissolves in the DME, and thereafter, as time passes, gradually becomes closer to the concentration (10%) for before made to flow through DME. This is because after carbon dioxide in the DME is saturated, more carbon dioxide hardly dissolves in the DME. To confirm that the DME easily absorbs the toxic gas components such as nitrogen oxides and sulfur oxides, the inventors conducted an experiment wherein model gas including the toxic gas components (nitrogen dioxide: 60 ppm, sulfur dioxide: 80 ppm, ammonia: 10 ppm) is made to flow through DME. As a result, it was confirmed that all the toxic gas components in the model gas became 1 ppm or less in concentration in about an hour after the model gas starts to flow through DME.

Next, a specific scheme of the exhaust gas processing system of the present embodiment will be described in detail. First, in the preprocess, exhaust gas including toxic gas components such as nitrogen oxides and sulfur oxides, exhausted from the exhaust gas source 10 is introduced into the heat exchanger 11, in which seawater (at, e.g., 25° C.) supplied via a seawater pump 12 and a coolant such as ethylene glycol circulated from a refrigerator 40 are introduced. The exhaust gas (at, e.g., 55° C.) introduced from the exhaust gas source 10 passes through the heat exchanger 11 and thereby is cooled by the seawater and the coolant to about room temperature.

The exhaust gas cooled to about room temperature in the heat exchanger 11 is then introduced into the condenser 13, and the exhaust gas introduced in the condenser 13 is introduced into industrial water contained in the condenser 13. Thereby, moisture, the toxic gas components, dust, and the like contained in the exhaust gas are removed. The liquefied water including the moisture, the toxic gas components, the dust, and the like removed from the exhaust gas is temporarily stored in an effluent cistern 14 and then introduced into an effluent processing apparatus 50 by an effluent pump 15. The exhaust gas having passed through the condenser 13 is then introduced by an exhaust gas fan 16 into the dehydrating tower 17. Note that heat exchange with the industrial water in the condenser 13 cools the exhaust gas from about room temperature to, e.g., 5° C.

In the dehydrating tower 17, the exhaust gas is further dehydrated and has the toxic gas components removed. By removing moisture contained in the exhaust gas, carbon dioxide contained in the exhaust gas can be retrieved efficiently in the retrieval process that is executed later.

The exhaust gas is introduced into the dehydrating tower 17 at its lower end. The exhaust gas (at, e.g., 5° C.) introduced in the dehydrating tower 17 is made to flow through DME as coolant for cooling the exhaust gas, with which the dehydrating tower 17 is filled, according to a bubbling method. The exhaust gas introduced in the dehydrating tower 17 is cooled through heat exchange with the DME to a cooling temperature, at which moisture and toxic gas components such as nitrogen oxides and sulfur oxides contained in the exhaust gas are liquefied or solidified while carbon dioxide is not solidified. By cooling the exhaust gas to such a temperature, the toxic gas components are liquefied or solidified and thus separated from the exhaust gas while carbon dioxide remains gas in the exhaust gas.

In order to confirm the function of the dehydrating tower 17 to remove the toxic gas components from the exhaust gas, the amounts of sulfur dioxide (SO₂) and nitrogen monoxide (NO) dissolving in the coolant were measured. FIG. 2B shows the configuration of an apparatus used in this measurement. As shown in the Figure, this apparatus 210 has a mixer 211 that produces a model exhaust gas, a cooling container 212 (e.g., a test tube or a beaker) for cooling the model exhaust gas that simulates the dehydrating tower 17, a gas introducing pipe 213 that introduces the model exhaust gas into the cooling container 212, and a gas exhausting pipe 214 for discharging gas accumulating above the cooling container 212 outside the cooling container 212, which are connected as shown in the Figure.

The cooling container 212 contains toluene (from 0 to 5° C., in an amount of 100 cc) as the coolant. The gas introducing pipe is set such that its opening is located below the liquid surface of the toluene. Furthermore, a mixture of carbon dioxide (CO₂), sulfur dioxide (SO₂), nitrogen monoxide (NO), and nitrogen (N₂) mixed by the mixer was used as the model exhaust gas. FIG. 2C shows the composition of the model exhaust gas. Measurement was made while the model exhaust gas was being introduced at a constant speed of 1 l/h.

FIG. 2D shows the measurement results. In the Figure, the measurement results are shown on a graph representing relationships between the temperature of the coolant (toluene) and the dissolving amounts (ppm) of sulfur dioxide (SO₂) and nitrogen monoxide (NO). The two curves drawn in the graph represent theoretical values calculated according to an SRK (Soave-Redlich-Kwong) respectively for the dissolving amounts (ppm) of sulfur dioxide (SO₂) and nitrogen monoxide (NO). The circles marked on the graph indicate actual measured values obtained by the measurement, and the actual measured value of the dissolving amount of sulfur dioxide (SO₂) is 48 (ppm) and the actual measured value of the dissolving amount of nitrogen monoxide (NO) is 0.1 (ppm). Here, at the temperature corresponding to the marked circles, the theoretical value of the dissolving amount of sulfur dioxide (SO₂) is 36 (ppm) and the actual measured value of the dissolving amount of nitrogen monoxide (NO) is 0.07 (ppm). It is seen that either of the actual measured values almost coincides with its theoretical value.

From the above measurement, it was confirmed that the dissolving amounts of sulfur dioxide (SO₂) and nitrogen monoxide (NO) according to the temperature of the coolant can be theoretically obtained, and also that the toxic gas components can be separated efficiently from the exhaust gas in the dehydrating tower 17.

The DME is cooled in a DME cooling tower 18 and supplied circularly to the dehydrating tower 17. Through the DME cooling tower 18, coolant (liquid nitrogen) cooled by the refrigerator 40 is circulated by a circulation pump 19. The DME is cooled through heat exchange with the coolant.

By making the exhaust gas flow through the dehydrating tower 17, the DME comes to contain moisture and the toxic gas components liquefied or solidified, and is introduced into a DME separation tower 20 for reuse. The DME introduced in the DME separation tower 20 is raised in temperature (to, e.g., −20° C.) through indirect heat exchange with seawater. At this temperature, the moisture and the toxic gas components are liquid or solid, while the DME is gas. Hence, the DME rises to the upper portion of the DME separation tower 20, thereby being separated from the other components. The DME that has risen to the upper portion of the DME separation tower 20 is retrieved from there and introduced into the DME cooling tower 18, and then introduced into the dehydrating tower 17. In this way, the DME is circulated and used effectively. Also, by reusing the DME as coolant circularly in this way, the exhaust gas processing system of the embodiment as a whole is operated to use the coolant efficiently.

The liquid or solid moisture and toxic gas components from the dehydrating tower 17 that remain in the DME separation tower 20 are introduced by a transfer pump 21 into a component separation tower 22. The moisture and toxic gas components introduced in the component separation tower 22 are raised in temperature (to, e.g., 5° C.) through indirect heat exchange with seawater in the component separation tower 22. At this temperature, the moisture and nitrogen dioxide are liquid and sulfur dioxide is gas. The sulfur dioxide gas is discharged from the upper side of the component separation tower 22 and introduced into the heat exchanger 11, so as to be used as coolant for cooling exhaust gas (at, e.g., 5° C.) from the exhaust gas source 10. By using sulfur dioxide as coolant in this way, energy consumption of the entire system for cooling is suppressed, thus realizing efficient processing.

The exhaust gas after used as coolant is raised in temperature (to, e.g., 45° C.) through heat exchange, and discharged through a smokestack 51 outside the system. Meanwhile, except the sulfur dioxide, liquefied water and toxic gas components such as nitrogen dioxide that remain in the component separation tower 22 are introduced into the effluent processing apparatus 50.

Exhaust gas including carbon dioxide that has risen to the upper portion of the dehydrating tower 17 is introduced into a reversible heat exchanger 23. The exhaust gas introduced in the reversible heat exchanger 23 is cooled through heat exchange with exhaust gas from a cyclone 25, described later, in the reversible heat exchanger 23, and then introduced into the dry ice sublimator 24. The exhaust gas introduced in the dry ice sublimator 24 is cooled through indirect heat exchange with coolant (liquid nitrogen) circulated through the dry ice sublimator 24 via the refrigerator 40.

In order to confirm the retrieval rate of carbon dioxide (CO₂) in the dry ice sublimator 24, the retrieval rate of carbon dioxide (CO₂) against the temperature of model gas was measured. FIGS. 2E, 2F show the configuration of the dry ice sublimator 24 used in this measurement. FIG. 2E is a side view of the dry ice sublimator 24 and FIG. 2F is a side view of the dry ice sublimator 24 as seen in the direction indicated by an arrow A in FIG. 2E. As shown in the Figures, the dry ice sublimator 24 comprises two first cylinders 241 arranged upright (made of, e.g., SUS304) and a second cylinder 242 arranged in a horizontal position under the first cylinders 241 (that is, perpendicular to the first cylinders 241), which is in communication with the insides of the first cylinders 241. A coolant flow pipe 244 (material: copper; 900 mm in length, 20 turns, an outside area of 7.1 m²) through which coolant (e.g., liquid nitrogen) is circulated is placed inside the first cylinders 241. On the outside of the coolant flow pipe 244, screw-like fins (not shown) are formed to enlarge the contact area with carbon dioxide (CO₂). The ends of the first cylinders 241 and the second cylinder 242 are each closed by a stopper 246.

A mixture of 15% of carbon dioxide (CO₂) and 85% of nitrogen (N₂) is used as the model gas. Measurement was made while the model gas was made to flow through by being introduced at flow speed of 670 l/minute through an inlet 248 made in one of the first cylinders 241 at a predetermined position and discharged from an outlet 249 made in the other first cylinder 241 at a predetermined position. By contacting the outside of the coolant flow pipe 244, the model gas introduced into the inside space 247 of the dry ice sublimator 24 is cooled to such a temperature that carbon dioxide (CO₂) solidifies while nitrogen (N₂) does not. Thus, the carbon dioxide in the model gas becomes dry ice, which deposits in the second cylinder 242. Also, the nitrogen component in the model gas is discharged from the outlet 249.

FIG. 2G shows the measurement results. In the Figure, a relationship between the temperature of the model gas discharged from the outlet 249 and the retrieval rate of carbon dioxide (CO₂) is indicated by a graph for when model gas containing carbon dioxide (CO₂) in a concentration of 15% is used. As the measurement results show, it was confirmed that carbon dioxide (CO₂) can be retrieved efficiently by the dry ice sublimator 24.

Dry ice generated in the dry ice sublimator 24 is introduced into the cyclone 25, which separates dry ice and exhaust gas. Of them, the exhaust gas is introduced into the reversible heat exchanger 23 and used as coolant as mentioned previously. Because the exhaust gas cooled in the dry ice sublimator 24 is used as coolant in the reversible heat exchanger 23, energy consumption of the entire system for cooling is suppressed, thus realizing efficient processing. The exhaust gas used as coolant in the reversible heat exchanger 23 is introduced into the heat exchanger 11 and again used as coolant in the heat exchanger 11. Then, it is discharged through the smokestack 51 outside the system. To discharge the exhaust gas into the atmosphere is to discharge part of the exhaust gas outside the system to lessen the accumulation of the exhaust gas in the system. Therefore, carbon dioxide in the exhaust gas discharged into the atmosphere is very low in concentration.

Dry ice separated by the cyclone 25 is introduced into a dry ice melting device 26. The dry ice introduced in the dry ice melting device 26 is pressured and liquefied. By liquefying dry ice, carbon dioxide is improved in storability and transferability, and becomes easy to handle. In order to liquefy efficiently dry ice produced in a large amount, a device using a screw-type push-out mechanism disclosed in Japanese Patent Application Laid-Open Publication No. 2000-317302, etc., or the like is used as the dry ice melting device 26. The liquefied carbon dioxide is stored in a liquefied-carbonic acid storage 27 and used as liquefied carbonic acid for various purposes.

Instead of the configuration including the dry ice sublimator 24, the cyclone 25, and the dry ice melting device 26 shown in FIG. 1, the configuration of the dry ice sublimator 24 of FIG. 2E can be adopted. In this case, three or more of the first cylinders 241 may be used, not being limited to two of them.

Here, the refrigerator 40 cools nitrogen gas as coolant by compressing and expanding repeatedly with use of energy such as electrical energy. The liquid nitrogen produced by cooling is used to cool ethylene glycol that is circulated through the heat exchanger 11 and to cool coolant such as liquid nitrogen that is circulated through the DME cooling tower 18, the dry ice sublimator 24, etc., in paths separate from that for this liquid nitrogen. The refrigerator 40 comprises a turbine compressor 41 (a nitrogen pressurizing device), a circulated nitrogen compressor 42, a refrigerating device 43 for expanding the coolant to achieve a low temperature, a heat exchanger 44 that has liquid nitrogen as coolant exchange heat with the ethylene glycol and liquid nitrogen circulated via the separate paths, and the like.

As described above, the exhaust gas processing system of the present embodiment can efficiently remove moisture and toxic gas components from exhaust gas including the toxic gas components such as nitrogen oxides and sulfur oxides, exhausted from a coal burning boiler, a heavy oil burning boiler, or a blast furnace, coke oven, or converter of an ironwork, and further, can efficiently retrieve carbon dioxide from the exhaust gas while removing moisture and toxic gas components efficiently.

Here, toxic gases to be removed from exhaust gas include, for example, carbon monoxide, nitrogen oxides (NOₓ) such as nitrogen monoxide, sulfur oxides (SOₓ) such as sulfur monoxide, and halogen compounds such as hydrogen fluoride. By setting the solidifying temperature of carbon dioxide and the liquefying or solidifying temperature of the toxic gas components appropriately and selecting an appropriate one as the coolant, the toxic gas components can be removed efficiently. That is, an exhaust gas processing system can be realized wherein by making exhaust gas that includes another type of toxic gas flow through coolant to cool it to a first temperature, the toxic gas contained in the exhaust gas is liquefied or solidified and separated from the exhaust gas, and wherein by cooling the exhaust gas to a second temperature lower than the first temperature, carbon dioxide contained in the exhaust gas is solidified and separated from the exhaust gas.

### Second Embodiment

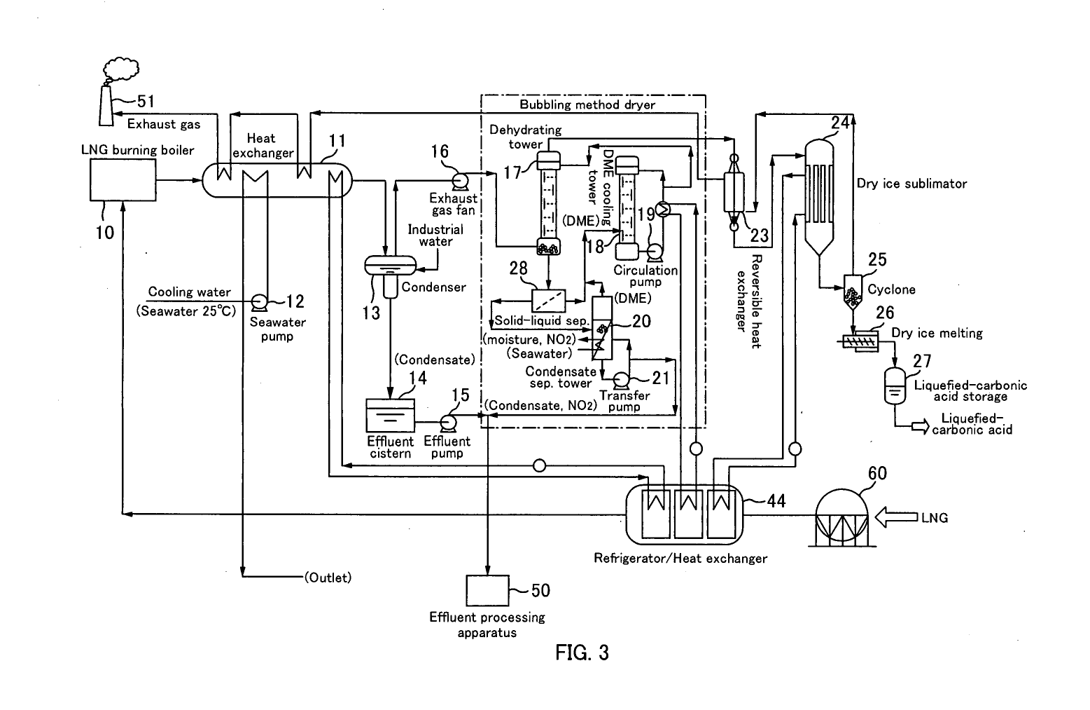

FIG. 3 shows the schematic configuration of an exhaust gas processing system according to a second embodiment of the present invention. The exhaust gas processing system of the present embodiment provides a scheme that efficiently retrieves carbon dioxide contained in exhaust gas including toxic gas components such as nitrogen oxides, exhausted from an exhaust gas source 10 such as an LNG burning boiler of a generating station, chemical plant, etc., while efficiently removing moisture and toxic gas components contained in the exhaust gas.

In this exhaust gas processing system, in its preprocess, exhaust gas including toxic gas components such as nitrogen oxides, exhausted from the exhaust gas source 10 is introduced into industrial water contained in a heat exchanger 11 and a condenser 13 and thereby cooled to about room temperature. Then, in a first process, the exhaust gas cooled to about room temperature is cooled in a dehydrating tower 17 to such a first temperature as not to solidify carbon dioxide, and thereby moisture and nitrogen oxides contained in the exhaust gas are liquefied or solidified and thus separated from the exhaust gas. Next, in a second process, the exhaust gas has moisture and nitrogen oxides separated therefrom is cooled in a dry ice sublimator 24 to a second temperature lower than the first temperature, and thereby carbon dioxide contained in the exhaust gas is solidified and separated from the exhaust gas.

The toxic gas components separated in the first process are mixed with the coolant. The coolant is preferably circulated and used effectively in order to operate the exhaust gas processing system efficiently. Accordingly, in this embodiment, with use of the evaporation method using the difference in evaporation temperature between the coolant and the toxic gas components, the coolant is separated from the toxic gas components and retrieved, and the retrieved coolant is again used as coolant. Note that although the evaporation method needs energy for heating, the energy can be reduced by adopting a coolant having a low boiling point.

In order to retrieve carbon dioxide contained in the exhaust gas efficiently in the second process, the carbon dioxide needs to be not liquefied or solidified when moisture and the toxic gas components are liquefied or solidified. Carbon dioxide in heat power station exhaust gas solidifies into dry ice below a predetermined temperature. Hence, in order not to allow the carbon dioxide to solidify, gas temperature at the exit of the dehydrating tower 17 is made to be higher than the predetermined temperature.

In the first process, the coolant itself is required to have the property of not solidifying at temperatures at which the toxic gas components are liquefied or solidified in order to separate the coolant from the toxic gas components liquefied or solidified. Further, to liquefy or solidify the toxic gas components efficiently, the coolant is required to have the property of absorbing the toxic gas components easily. Yet further, to retrieve carbon dioxide from the exhaust gas efficiently in the second process, the coolant is required to have the property that carbon dioxide does not easily dissolve therein.

A specific coolant that satisfies these requirements is dimethyl ether (hereinafter, called DME; freezing point: −141.5° C., boiling point: −24.9° C.). Other materials than dimethyl ether can be used as the coolant as long as they satisfy the requirements for it. For example, inorganic salts (sodium chloride, potassium chloride, etc.), bromine compounds (lithium bromide, bromo bromide, etc.), ethers (dimethyl ether, methyl ether, etc.), alcohols (methanol, ethanol, etc.), silicon oils, paraffinic hydrocarbon (propane, butane, etc.), olefin-base hydrocarbon, and the like can be used as the coolant, which satisfy the requirements. Specifically, methanol, ethanol, toluene, ethyl benzene, and the like can be used as the coolant. In order to separate the toxic gas components liquefied or solidified from the coolant, the greater difference in boiling point between the coolant and the toxic gas components is more advantageous. From such a point of view, ethers and alcohols are preferred as the coolant.

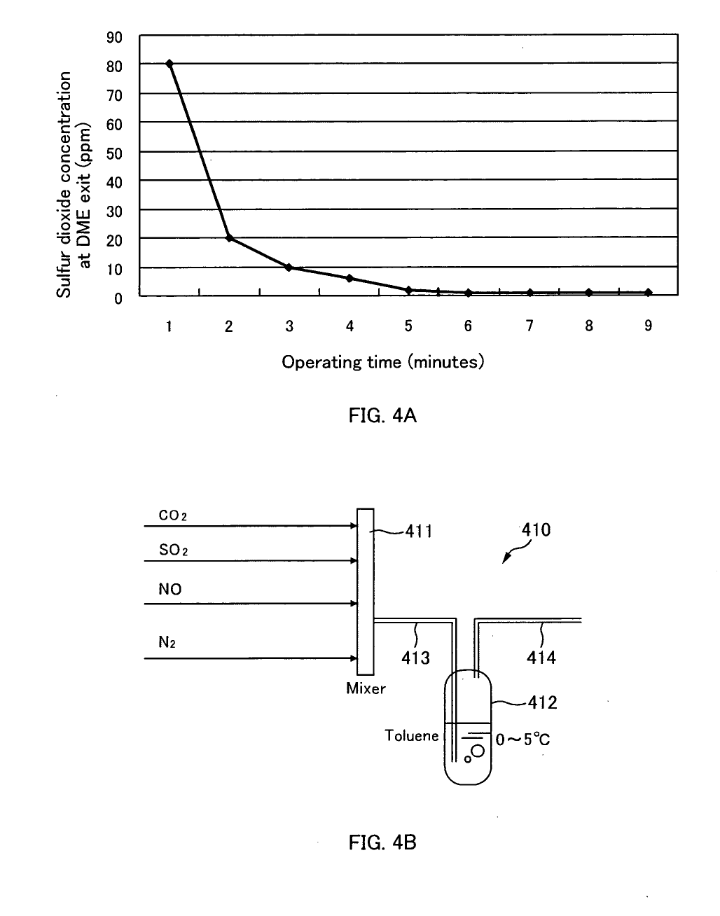

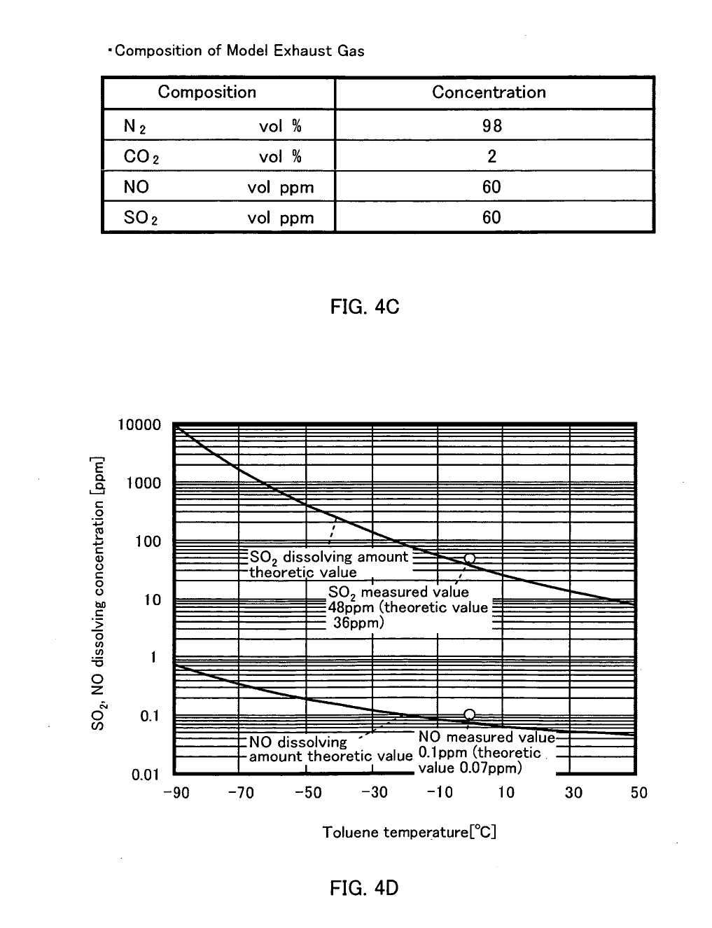

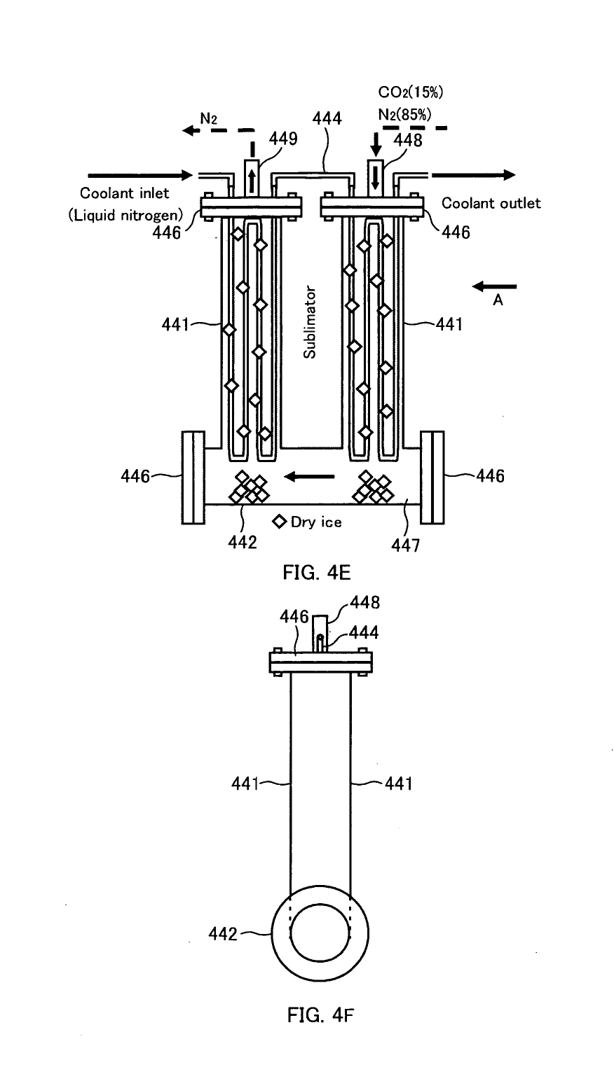

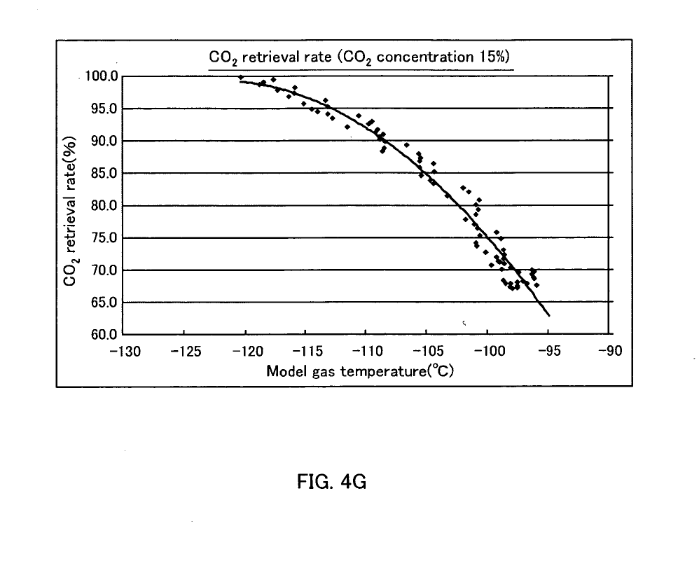

FIG. 4A shows results of measuring change in the concentration of carbon dioxide in the model gas when model gas having carbon dioxide in a concentration of 10% is made to flow through DME. As shown in the Figure, the concentration of carbon dioxide in the model gas decreases temporarily at the time when the model gas starts to flow through DME because the model gas dissolves in the DME, and thereafter, as time passes, gradually becomes closer to the concentration (10%) for before the circulation through DME. This is because after carbon dioxide in the DME is saturated, more carbon dioxide hardly dissolves in the DME. To confirm that the DME easily absorbs the toxic gas components such as nitrogen oxides, the inventors conducted an experiment of circulating model gas including the toxic gas components (nitrogen dioxide: 60 ppm, sulfur dioxide: 80 ppm, ammonia: 10 ppm) through DME. As a result, it was confirmed that all the toxic gas components in the model gas became 1 ppm or less in concentration in about an hour after the model gas starts to flow through DME.

Next, a specific scheme of the exhaust gas processing system of the present embodiment will be described in detail. First, in the preprocess, exhaust gas including toxic gas components such as nitrogen oxides, exhausted from the exhaust gas source 10 such as an LNG burning boiler is introduced into the heat exchanger 11, in which seawater (at, e.g., 25° C.) supplied via a seawater pump 12 and a coolant such as ethylene glycol circulated from a refrigerator 40 are introduced. The exhaust gas (at, e.g., 55° C.) introduced from the exhaust gas source 10 passes through the heat exchanger 11 and thereby is cooled by the seawater and the coolant to about room temperature.

The exhaust gas cooled to about room temperature in the heat exchanger 11 is then introduced into the condenser 13, and the exhaust gas introduced in the condenser 13 is introduced into industrial water contained in the condenser 13. Thereby, moisture, the toxic gas components, dust, and the like contained in the exhaust gas are removed. The liquefied water including the moisture, the toxic gas components, the dust, and the like removed from the exhaust gas is temporarily stored in an effluent cistern 14 and then introduced into an effluent processing apparatus 50 by an effluent pump 15. The exhaust gas having passed through the condenser 13 is then introduced by an exhaust gas fan 16 into the dehydrating tower 17. Note that heat exchange with the industrial water in the condenser 13 cools the exhaust gas to about room temperature (5° C., for example).

In the dehydrating tower 17, the exhaust gas is further dehydrated and has the toxic gas components removed. By removing moisture contained in the exhaust gas, carbon dioxide contained in the exhaust gas can be retrieved efficiently later.

The exhaust gas is introduced into the dehydrating tower 17 at its lower end. The exhaust gas (at, e.g., 5° C.) introduced in the dehydrating tower 17 is made to flow through DME as coolant for cooling the exhaust gas, with which the dehydrating tower 17 is filled, according to a bubbling method. The exhaust gas introduced in the dehydrating tower 17 is cooled through heat exchange with the DME to a cooling temperature, at which moisture and toxic gas components such as nitrogen oxides contained in the exhaust gas are liquefied or solidified while carbon dioxide is not solidified. By cooling the exhaust gas to such a temperature, the toxic gas components are liquefied or solidified and thus separated from the exhaust gas while carbon dioxide remains gas in the exhaust gas.

In order to confirm the function of the dehydrating tower 17 to remove the toxic gas components from the exhaust gas, the amounts of sulfur dioxide (SO₂) and nitrogen monoxide (NO) dissolving in the coolant were measured. FIG. 4B shows the configuration of an apparatus used in this measurement. As shown in the Figure, this apparatus 210 has a mixer 211 that produces a model exhaust gas, a cooling container 212 (e.g., a test tube or a beaker) for cooling the model exhaust gas that simulates the dehydrating tower 17, a gas introducing pipe 213 that introduces the model exhaust gas into the cooling container 212, and a gas exhausting pipe 214 for discharging gas accumulating above the cooling container 212 outside the cooling container 212, which are connected as shown in the Figure.

The cooling container 212 contains toluene (from 0 to 5° C., in an amount of 100 cc) as the coolant. The gas introducing pipe is set such that its opening is located below the liquid surface of the toluene. Furthermore, a mixture of carbon dioxide (CO₂), sulfur dioxide (SO₂), nitrogen monoxide (NO), and nitrogen (N₂) mixed by the mixer was used as the model exhaust gas. FIG. 4C shows the composition of the model exhaust gas. Measurement was made while the model exhaust gas was being introduced at a constant speed of 1 l/h.

FIG. 4D shows the measurement results. In the Figure, the measurement results are shown on a graph representing relationships between the temperature of the coolant (toluene) and the dissolving amounts (ppm) of sulfur dioxide (SO₂) and nitrogen monoxide (NO). The two curves drawn in the graph represent theoretical values calculated according to an SRK (Soave-Redlich-Kwong) respectively for the dissolving amounts (ppm) of sulfur dioxide (SO₂) and nitrogen monoxide (NO). The circles marked on the graph indicate actual measured values obtained by the measurement, and the actual measured value of the dissolving amount of sulfur dioxide (SO₂) is 48 (ppm) and the actual measured value of the dissolving amount of nitrogen monoxide (NO) is 0.1 (ppm). Here, at the temperature corresponding to the marked circles, the theoretical value of the dissolving amount of sulfur dioxide (SO₂) is 36 (ppm) and the actual measured value of the dissolving amount of nitrogen monoxide (NO) is 0.07 (ppm). It is seen that either of the actual measured values almost coincides with its theoretical value.

From the above measurement, it was confirmed that the dissolving amounts of sulfur dioxide (SO₂) and nitrogen monoxide (NO) according to the temperature of the coolant can be theoretically obtained, and also that the toxic gas components can be separated efficiently from the exhaust gas in the dehydrating tower 17.

The DME is supplied circularly from a DME cooling tower 18 that cools the DME to the dehydrating tower 17. Through the DME cooling tower 18, coolant (liquid nitrogen) cooled by the refrigerator/heat exchanger 44 is circulated by a circulation pump 19. The DME is cooled through heat exchange with the coolant.

By making the exhaust gas flow through the dehydrating tower 17, the DME comes to contain moisture and the toxic gas components liquefied or solidified, and is introduced into a solid-liquid separation tower 28. Note that in this stage, the DME and substances into which moisture and the toxic gas components have solidified are in a sherbet state (slurry). The solid-liquid separation tower 28 separates the DME and the solidified substances. The DME separated by the solid-liquid separation tower 28 is introduced into a DME separation tower 20 to reuse the DME. The DME introduced into the DME separation tower 20 has some of moisture and the toxic gas components remaining.

The DME from the dehydrating tower 17 introduced in the DME separation tower 20 is raised in temperature (to, e.g., 5° C.) through indirect heat exchange with seawater. At this temperature, the moisture and the toxic gas components are liquid or solid, while the DME is gas. Hence, the DME gas rises to the upper portion of the DME separation tower 20, thereby being separated from the other components. The DME that has risen to the upper portion of the DME separation tower 20 is retrieved from there and introduced into the DME cooling tower 18, and again introduced into the dehydrating tower 17. In this way, the DME is reused circularly. Also, by reusing the DME as coolant circularly, the exhaust gas processing system of the embodiment as a whole is operated to use the coolant efficiently. Meanwhile, the liquid or solid moisture and toxic gas components that remain in the DME separation tower 20 are introduced into the effluent processing apparatus 50.

Exhaust gas including carbon dioxide that has risen to the upper portion of the dehydrating tower 17 is introduced into a reversible heat exchanger 23. The exhaust gas introduced in the reversible heat exchanger 23 is cooled through heat exchange with exhaust gas from a cyclone 25, described later, in the reversible heat exchanger 23, and then introduced into the dry ice sublimator 24. The exhaust gas introduced in the dry ice sublimator 24 is cooled through indirect heat exchange with coolant (liquid nitrogen) circulated through the dry ice sublimator 24 via the refrigerator/heat exchanger 40.

In order to confirm the retrieval rate of carbon dioxide (CO₂) in the dry ice sublimator 24, the retrieval rate of carbon dioxide (CO₂) against the temperature of model gas were measured. FIGS. 4E, 4F show the configuration of the dry ice sublimator 440 used in this measurement. FIG. 4E is a side view of the dry ice sublimator 440 and FIG. 4F is a side view of the dry ice sublimator 440 as seen in the direction indicated by an arrow A in FIG. 4E. As shown in the Figures, the dry ice sublimator 440 comprises two first cylinders 441 arranged upright (made of, e.g., SUS304) and a second cylinder 442 arranged in a horizontal position under the first cylinders 441 (that is, perpendicular to the first cylinders 441), which is in communication with the insides of the first cylinders 441. A coolant flow pipe 444 (material: copper; 900 mm in length, 20 turns, an outside area of 7.1 m²) through which coolant (e.g., liquid nitrogen) is circulated is placed inside the first cylinders 441. On the outside of the coolant flow pipe 444, screw-like fins (not shown) are formed to enlarge the contact area with carbon dioxide (CO₂). The ends of the first cylinders 441 and the second cylinder 442 are each closed by a stopper 446.

A mixture of 15% of carbon dioxide (CO₂) and 85% of nitrogen (N₂) is used as the model gas. Measurement was made while the model gas was made to flow through by being introduced at flow speed of 670 l/minute through an inlet 448 made in one of the first cylinders 441 at a predetermined position and discharged from an outlet 449 made in the other first cylinder 441 at a predetermined position. By contacting the outside of the coolant flow pipe 444, the model gas introduced into the inside space 447 of the dry ice sublimator 440 is cooled to such a temperature that carbon dioxide (CO₂) solidifies while nitrogen (N₂) does not. Thus, the carbon dioxide in the model gas becomes dry ice, which deposits in the second cylinder 442. Also, the nitrogen component in the model gas is discharged from the outlet 449.

FIG. 4G shows the measurement results. In the Figure, a relationship between the temperature of the model gas discharged from the outlet 449 and the retrieval rate of carbon dioxide (CO₂) is indicated by a graph for when model gas containing carbon dioxide (CO₂) in a concentration of 15% is used. As the measurement results show, it was confirmed that carbon dioxide (CO₂) can be retrieved efficiently by the dry ice sublimator 24.

Dry ice generated in the dry ice sublimator 24 is introduced into the cyclone 25, which separates dry ice and exhaust gas. The separated exhaust gas is introduced into the reversible heat exchanger 23 and functions as coolant as mentioned previously. Because the exhaust gas cooled in the dry ice sublimator 24 functions as coolant in the reversible heat exchanger 23, energy consumption of the entire system for cooling is suppressed, thus realizing efficient processing. The exhaust gas used as coolant in the reversible heat exchanger 23 is introduced into the heat exchanger 11 and again used as coolant in the heat exchanger 11. Then, it is discharged through the smokestack 51 outside the system. To discharge the exhaust gas into the atmosphere is to discharge part of the exhaust gas outside the system to lessen the accumulation of the exhaust gas in the system. Therefore, carbon dioxide in the exhaust gas discharged into the atmosphere is very low in concentration.

Dry ice separated by the cyclone 25 is introduced into a dry ice melting device 26, which pressures and liquefies the dry ice. By liquefying dry ice, carbon dioxide is improved in storability and transferability, and becomes easy to handle. In order to liquefy efficiently dry ice produced in a large amount, a device using a screw-type push-out mechanism disclosed in Japanese Patent Application Laid-Open Publication No. 2000-317302, etc., or the like is used as the dry ice melting device 26. The liquefied carbon dioxide is stored in a liquefied-carbonic acid storage 27 and used as liquefied carbonic acid for various purposes.

Instead of the configuration including the dry ice sublimator 24 and the cyclone 25 shown in FIG. 3, the configuration of the dry ice sublimator 440 of FIG. 4E can be adopted. In this case, three or more of the first cylinders 441 may be used, not being limited to two of them.

Here, the refrigerator/heat exchanger 44 cools ethylene glycol that is circulated through the heat exchanger 11 and coolant such as liquid nitrogen that is circulated through the DME cooling tower 18, the dry ice sublimator 24, etc., by use of the heat of vaporization of LNG 60. In, e.g., a generating station using LNG as gas fuel, the LNG is transported in a liquid state (at a temperature of, e.g., −150 to −165° C.) and stored in an LNG tank or the like. When the LNG is used as gas fuel, the LNG obtains the heat of vaporization from the atmosphere or seawater to rise in temperature and vaporize, while the refrigerator/heat exchanger 44 cools coolants such as ethylene glycol and liquid nitrogen by using this heat of vaporization. That is, exhaust gas or coolant is cooled by using the heat of vaporization that is produced when the LNG is used as gas fuel. Technology of solidifying and separating carbon dioxide contained in exhaust gas by using the heat of vaporization of LNG is disclosed in, e.g., Japanese Patent Application Laid-Open Publication No. H08-12314 or the like.

As described above, the exhaust gas processing system of the present embodiment can efficiently remove moisture and toxic gas components from exhaust gas including the toxic gas components such as nitrogen oxides, exhausted from an LNG burning boiler or the like, and further, can efficiently retrieve carbon dioxide from the exhaust gas while removing moisture and toxic gas components efficiently.

Here, toxic gases to be removed from exhaust gas include, for example, carbon monoxide, nitrogen oxides (NOₓ) such as nitrogen monoxide, sulfur oxides (SOₓ) such as sulfur monoxide, and halogen compounds such as hydrogen fluoride. By setting the solidifying temperature of carbon dioxide and the liquefying or solidifying temperature of the toxic gas components appropriately and selecting an appropriate one as the coolant, the toxic gas components can be removed efficiently. That is, an exhaust gas processing system can be realized wherein by making exhaust gas that includes another type of toxic gas flow through coolant to cool it to a first temperature, the toxic gas contained in the exhaust gas is liquefied or solidified and separated from the exhaust gas, and wherein by cooling the exhaust gas to a second temperature lower than the first temperature, carbon dioxide contained in the exhaust gas is solidified and separated from the exhaust gas.

### Third Embodiment

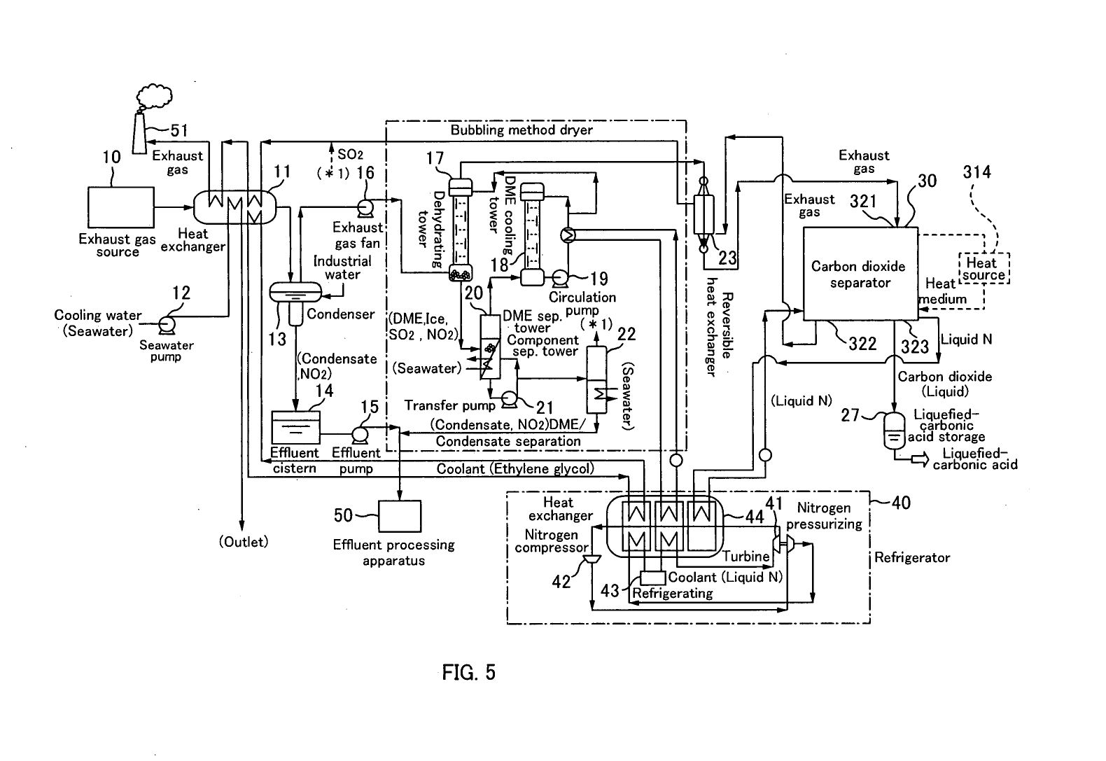

FIG. 5 shows the schematic configuration of an exhaust gas processing system according to a third embodiment of the present invention. The exhaust gas processing system of the present embodiment can efficiently, reliably remove moisture and toxic gas components from exhaust gas including the toxic gas components such as nitrogen oxides and sulfur oxides, exhausted from an exhaust gas source 10 such as a coal burning boiler or a heavy oil burning boiler of a generating station, chemical plant, etc., or a blast furnace, coke oven, or converter of an ironwork, and can efficiently and reliably retrieve carbon dioxide from the exhaust gas.

In the exhaust gas processing system of the present embodiment, in its preprocess, exhaust gas including toxic gas components such as nitrogen oxides and sulfur oxides, exhausted from the exhaust gas source 10 is introduced into industrial water contained in a heat exchanger 11 and a condenser 13 and thereby cooled to about room temperature. Then, in a first process, the exhaust gas cooled to about room temperature is cooled in a dehydrating tower 17 to such a first temperature as not to solidify carbon dioxide, and thereby moisture, sulfur oxides, and nitrogen oxides contained in the exhaust gas are liquefied or solidified and thus separated from the exhaust gas. Next, in a second process, the exhaust gas has moisture, nitrogen oxides, and sulfur oxides separated therefrom is introduced into a carbon dioxide separator 30, which cools and solidifies carbon dioxide contained in the exhaust gas to separate it and then liquefies and discharges the separated carbon dioxide.

Although the toxic gas components separated in the first process are mixed with the coolant, the coolant is preferably circulated and used effectively in order to operate the exhaust gas processing system efficiently. Accordingly, in this embodiment, with use of an evaporation method using the difference in evaporation temperature between the coolant and the toxic gas components, the coolant is separated from the toxic gas components and retrieved, and the retrieved coolant is again used as coolant. Note that although the evaporation method needs energy for heating, the energy can be reduced by adopting a coolant having a low boiling point.

In order to retrieve carbon dioxide contained in the exhaust gas efficiently in the second process, the carbon dioxide needs to be not liquefied or solidified when moisture and the toxic gas components are liquefied or solidified. Carbon dioxide in heat power station exhaust gas solidifies into dry ice below a predetermined temperature. Hence, in order not to allow the carbon dioxide to solidify, gas temperature at the exit of the dehydrating tower 17 is made to be higher than the predetermined temperature.

In the first process, the coolant itself is required to have the property of not solidifying at temperatures at which the toxic gas components are liquefied or solidified in order to separate the coolant from the toxic gas components liquefied or solidified. Further, to liquefy or solidify the toxic gas components efficiently, the coolant is required to have the property of absorbing the toxic gas components easily. Yet further, to retrieve carbon dioxide from the exhaust gas efficiently in the second process, the coolant is required to have the property that carbon dioxide does not easily dissolve therein.

A specific coolant that satisfies these requirements is, for example, dimethyl ether (hereinafter, called DME), inorganic salts (sodium chloride, potassium chloride, etc.), bromine compounds (lithium bromide, bromo bromide, etc.), ethers (dimethyl ether, methyl ether, etc.), alcohols (methanol, ethanol, etc.), silicon oils, paraffinic hydrocarbon (propane, butane, etc.), olefin-base hydrocarbon, toluene, ethyl benzene, or the like. In order to separate the toxic gas components liquefied or solidified from the coolant, the greater difference in boiling point between the coolant and the toxic gas components is more advantageous. From such a point of view, ethers and alcohols are preferred as the coolant.

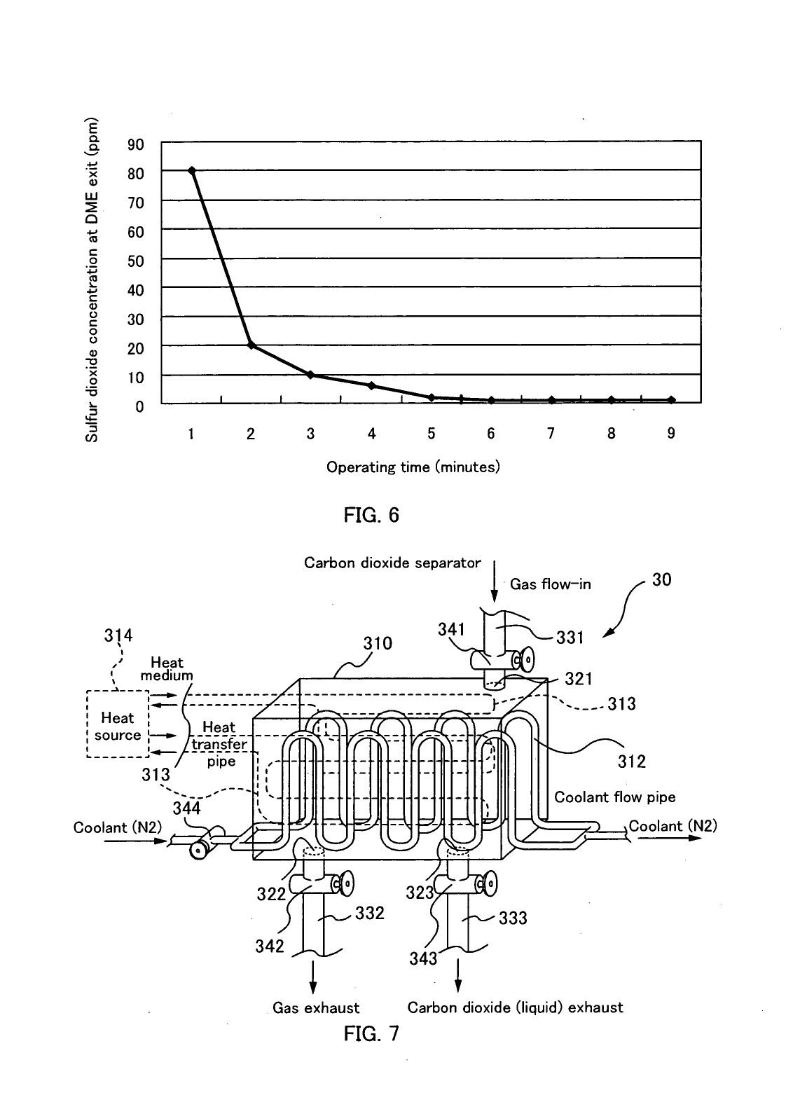

FIG. 6 shows the change in the concentration of carbon dioxide in the model gas when model gas having carbon dioxide in a concentration of 10% is made to flow through DME. The concentration of carbon dioxide in the model gas decreases temporarily at the time when the model gas starts to flow through DME because the model gas dissolves in the DME, and thereafter, as time passes, gradually becomes closer to the concentration (10%) for before the circulation through DME. This is because after carbon dioxide in the DME is saturated, more carbon dioxide hardly dissolves in the DME. To confirm that the DME easily absorbs the toxic gas components such as nitrogen oxides and sulfur oxides, the inventors conducted an experiment of circulating model gas including the toxic gas components (nitrogen dioxide: 60 ppm, sulfur dioxide: 80 ppm, ammonia: 10 ppm) through DME. As a result, it was confirmed that all the toxic gas components in the model gas became 1 ppm or less in concentration in about an hour after the model gas starts to flow through DME.

Next, specific processes of the exhaust gas processing system of the present embodiment will be described sequentially. First, in the preprocess, exhaust gas including toxic gas components such as nitrogen oxides and sulfur oxides, exhausted from the exhaust gas source 10 such as a coal burning boiler or a heavy oil burning boiler, or a blast furnace, coke oven, or converter of an ironwork, is introduced into the heat exchanger 11, in which seawater (at, e.g., 25° C.) supplied via a seawater pump 12 and a coolant such as ethylene glycol circulated from a refrigerator 40 are introduced. The exhaust gas (at, e.g., 55° C.) introduced from the exhaust gas source 10 passes through the heat exchanger 11 and thereby is cooled by the seawater and the coolant to about room temperature.

The cooled exhaust gas is introduced into the condenser 13, and then introduced into industrial water contained in the condenser 13. Thereby, moisture, the toxic gas components, dust, and the like contained in the exhaust gas are removed. The liquefied water including the moisture, the toxic gas components, the dust, and the like removed from the exhaust gas is temporarily stored in an effluent cistern 14 and then introduced into an effluent processing apparatus 50 by an effluent pump 15. The exhaust gas having passed through the condenser 13 is then introduced by an exhaust gas fan 16 into the dehydrating tower 17. Note that heat exchange with the industrial water in the condenser 13 cools the exhaust gas from about room temperature to 5° C., for example.

In the dehydrating tower 17, the exhaust gas is further dehydrated and has the toxic gas components removed. By removing moisture contained in the exhaust gas, carbon dioxide contained in the exhaust gas can be retrieved efficiently in the retrieval process that is executed later.

The exhaust gas is introduced into the dehydrating tower 17 at its lower end. The exhaust gas (at, e.g., 5° C.) introduced in the dehydrating tower 17 is made to flow through DME as coolant for cooling the exhaust gas, with which the dehydrating tower 17 is filled, according to a bubbling method. Then, the exhaust gas is cooled through heat exchange with the DME to a cooling temperature, at which moisture and toxic gas components such as nitrogen oxides and sulfur oxides contained in the exhaust gas are liquefied or solidified while carbon dioxide is not solidified. By cooling the exhaust gas to such a temperature, the toxic gas components are liquefied or solidified and thus separated from the exhaust gas while carbon dioxide remains gas in the exhaust gas.

The DME is supplied circularly from a DME cooling tower 18 to the dehydrating tower 17. To the DME cooling tower 18, coolant (liquid nitrogen) cooled by the refrigerator 40 is supplied circularly by a circulation pump 19. In the DME cooling tower 18, the DME is cooled through heat exchange with the coolant.

The DME through which the exhaust gas has flown in the dehydrating tower 17 is introduced into a DME separation tower 20. This DME contains moisture and toxic gas components liquefied or solidified. The DME introduced in the DME separation tower 20 is raised in temperature (to, e.g., −20° C.) through indirect heat exchange with seawater. At this temperature, the moisture and the toxic gas components are liquid or solid, while the DME is gas. Hence, the DME rises to the upper portion of the DME separation tower 20, thereby being separated from the other components. The risen DME is retrieved from the upper portion of the DME separation tower 20 and introduced into the DME cooling tower 18, and then introduced into the dehydrating tower 17. In this way, the DME is circulated and reused, and thus in the entire system the coolant is used efficiently.

The liquid or solid moisture and toxic gas components that remain in the DME separation tower 20 are introduced by a transfer pump 21 into a component separation tower 22, in which the moisture and toxic gas components are raised in temperature (to, e.g., 5° C.) through indirect heat exchange with seawater. At this temperature, the moisture and nitrogen dioxide are liquid and sulfur dioxide is gas. The sulfur dioxide that has become gas due to the raised temperature is discharged from the upper side of the component separation tower 22 and introduced into the heat exchanger 11, so as to be used as coolant for cooling exhaust gas (at, e.g., 55° C.) from the exhaust gas source 10. By using sulfur dioxide as coolant in this way, energy consumption of the entire system is suppressed.

The exhaust gas after used as coolant is raised in temperature (to, e.g., 45° C.) through heat exchange, and discharged through a smokestack 51 outside the system. Meanwhile, except the sulfur dioxide, liquefied water and toxic gas components such as nitrogen dioxide that remain in the component separation tower 22 are introduced into the effluent processing apparatus 50.

Exhaust gas including carbon dioxide that has risen to the upper portion of the dehydrating tower 17 is introduced into a reversible heat exchanger 23. The exhaust gas introduced in the reversible heat exchanger 23 is cooled there and introduced into the carbon dioxide separator 30. The carbon dioxide separator 30 separates carbon dioxide from the exhaust gas and liquefies and discharges the separated carbon dioxide. The detailed configuration and functions of the carbon dioxide separator 30 will be described later.

The liquefied carbon dioxide is transferred to and stored in a liquefied-carbonic acid storage 27. Meanwhile, the exhaust gas that has had carbon dioxide separated therefrom in the carbon dioxide separator 30 is introduced into the reversible heat exchanger 23 and used as coolant, and then is introduced into the heat exchanger 11. After being used as coolant in the heat exchanger 11, the exhaust gas is discharged into the atmosphere outside the system through the smokestack 51. The discharging into the atmosphere is to let part of the exhaust gas out to lessen the accumulation of the exhaust gas in the system. Therefore, carbon dioxide in the exhaust gas discharged is very low in concentration.

Here, the refrigerator 40 cools nitrogen gas as coolant by compressing and expanding repeatedly with use of energy such as electrical energy. The liquid nitrogen produced by cooling is used to cool ethylene glycol that is circulated through the heat exchanger 11 and to cool coolant such as liquid nitrogen that is circulated through the DME cooling tower 18, the dry ice sublimator 24, etc., in paths separate from that for this liquid nitrogen. The refrigerator 40 comprises a turbine compressor 41 (a nitrogen pressurizing device), a circulated nitrogen compressor 42, a refrigerating device 43 for expanding the coolant to achieve a low temperature, a heat exchanger 44 that has liquid nitrogen as coolant exchange heat with the ethylene glycol and liquid nitrogen circulated via the separate paths, and the like.

As described above, the exhaust gas processing system of the present embodiment can efficiently remove moisture and toxic gas components from exhaust gas including the toxic gas components such as nitrogen oxides and sulfur oxides, exhausted from a coal burning boiler, a heavy oil burning boiler, or a blast furnace, coke oven, or converter of an ironwork, and further, can efficiently retrieve carbon dioxide from the exhaust gas while removing moisture and toxic gas components efficiently.

Here, toxic gases to be removed from exhaust gas include, for example, carbon monoxide, nitrogen oxides (NOₓ) such as nitrogen monoxide, sulfur oxides (SOₓ) such as sulfur monoxide, and halogen compounds such as hydrogen fluoride. By setting the solidifying temperature of carbon dioxide and the liquefying or solidifying temperature of the toxic gas components appropriately and selecting an appropriate one as the coolant, the toxic gas components can be removed efficiently.

<Carbon Dioxide Separator 30>

The configuration and functions of the carbon dioxide separator 30 will be described in detail. FIG. 7 shows schematically the configuration of the carbon dioxide separator 30 according to the embodiment of the invention. In the Figure, a pressure-resistant container 310 is a substantially rectangular container made of metal (e.g., stainless) which is about several meters long, wide, and high. A gas inlet 321 to allow exhaust gas introduced from the reversible heat exchanger 23 to flow in through is made in the top surface of the pressure-resistant container 310 at a predetermined position. And, a gas outlet 322 to discharge the components other than carbon dioxide of the exhaust gas to the outside is made in the lower surface of the pressure-resistant container 310 at a predetermined position. Further, a liquid outlet 323 separate from the gas outlet 322 to discharge liquefied carbon dioxide that accumulates at the bottom of the pressure-resistant container 310 is made in the lower surface of the pressure-resistant container 310 at a predetermined position. In order to cause exhaust gas that has flown in through the gas inlet 321 to stay in the pressure-resistant container 310 for a predetermined period of time or longer, the gas outlet 322 is made at a position a predetermined distance away from the gas inlet 321.

A pipe connected to the gas inlet 321 (a gas flow-in pipe 331) is provided with a control valve 341 for adjusting the flow-in amount of exhaust gas. And, a pipe connected to the gas outlet 322 (a gas exhaust pipe 332) is provided with a control valve 342 for adjusting the exhaust amount of exhaust gas. Further, a pipe connected to the liquid outlet 323 (a liquid exhaust pipe 333) is provided with a control valve 343 for adjusting the amount of liquid carbon dioxide being discharged. By closing all the control valves 341, 342, 343, the pressure-resistant container 310 is put in an airtight closed state.

Inside the pressure-resistant container 310, a coolant flow pipe (cooler) 312 made of metal (e.g., copper or stainless) through which liquid nitrogen (LN₂) as coolant is circulated is disposed. The liquid nitrogen as coolant is supplied from the refrigerator 40. A control valve 341 to control the flow amount of coolant is provided upstream in the coolant flow pipe 312. In order to secure enough area of contact with exhaust gas flowing through the pressure-resistant container 310, the coolant flow pipe 312 divides into two parts in the coolant flow pipe 312. The coolant flow pipe 312 is serpentine in the pressure-resistant container, thus further securing enough area of contact with gas.

A heat transfer pipe (heat transfer device) 313 is buried in the wall of the pressure-resistant container 310. A control valve (not shown) to control the flow amount of a heat medium flowing through the heat transfer pipe 313 is provided upstream in the heat transfer pipe 313. The heat medium is, for example, dry air and transported from a heat source 314 to the heat transfer pipe 313. By using the coolant circulated from the refrigerator 40 as the heat medium, energy is effectively used in the system as whole. Instead of being buried in the wall of the pressure-resistant container 310, the heat transfer pipe 313 may be provided inside the pressure-resistant container 310. Also, instead of the heat transfer pipe 313, an electric heater (e.g., a silicon rubber heater or a fluorine resin heater) may be used.

The pressure-resistant container 310 is provided with various sensors such as a sensor to measure the temperature of gas in the pressure-resistant container 310 and a sensor to measure the temperature of the surface of the coolant flow pipe 312. The output value of each sensor is input to a measurement device or a computer (not shown) and monitored by an operator. A small window (not shown) is provided in the pressure-resistant container 310 at a predetermined position, through which the inside of the pressure-resistant container 310 can be viewed.

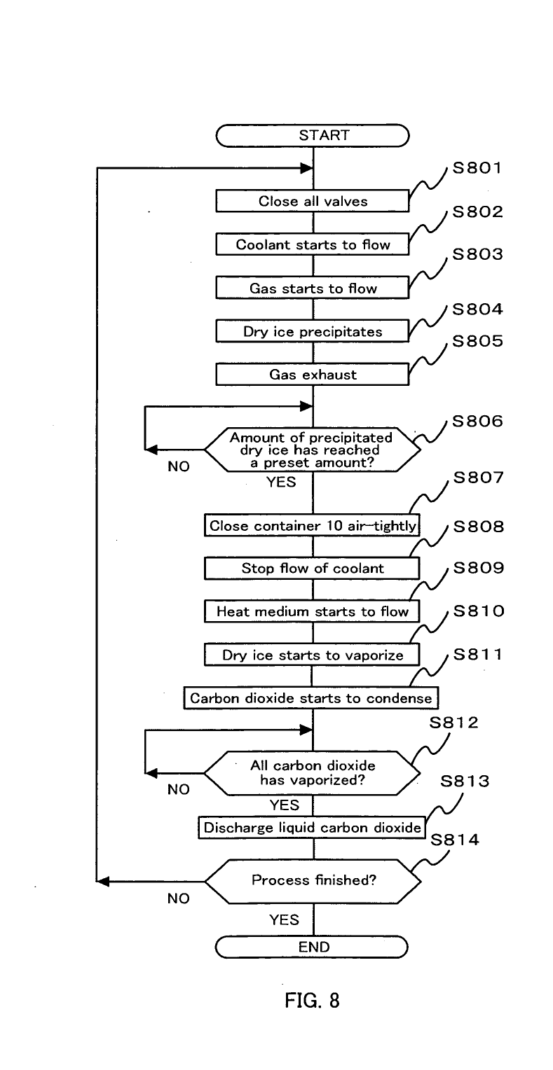

The process of separating carbon dioxide from exhaust gas by the carbon dioxide separator 30 will be described with reference to the process flow shown in FIG. 8. It is assumed that in an initial state, all the control valves 341, 342, 343 are closed (S801).

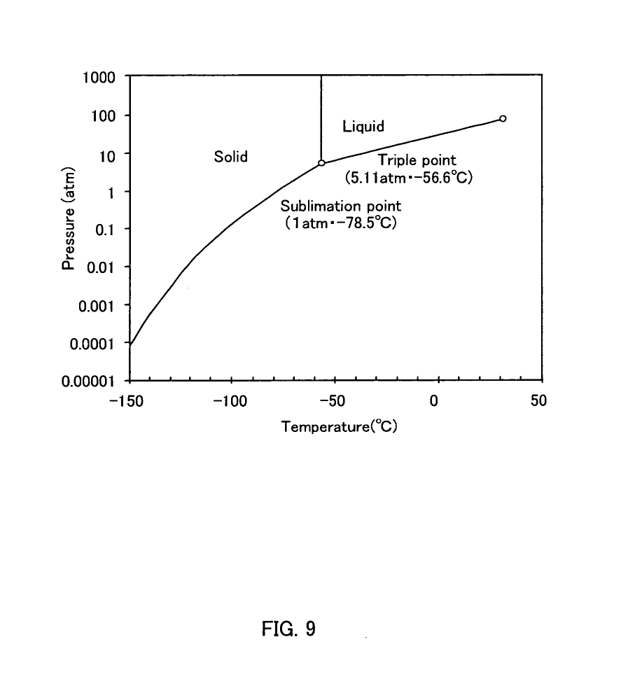

First, the control valve 344 is opened, and coolant (liquid nitrogen) starts to flow through the coolant flow pipe 312 (S802). Here, the temperature of the surface of the coolant flow pipe 312 is lowered to such a temperature that carbon dioxide solidifies while toxic gas components such as nitrogen oxides do not liquefy. FIG. 9 is a T-P (temperature-pressure) diagram for carbon dioxide. As shown in the Figure, the sublimation point of carbon dioxide is −78.5° C. at 1 atm. Therefore, if being at 1 atm is assumed, the temperature of the surface of the coolant flow pipe 312 is at least −78.5° C. or less.

When the temperature of the surface of the coolant flow pipe 312 reaches the above-mentioned temperature, then the control valves 341, 342 are opened, and thereby gas to have carbon dioxide separated flows in through the control valve 341, starting to flow through the pressure-resistant container 310 (S803). The gas flowing through the pressure-resistant container 310 is cooled by the coolant flow pipe 312, and thus carbon dioxide contained in the gas precipitates into dry ice 350 on the outside of the coolant flow pipe 312 (S804). Meanwhile, exhaust gas that has flown into the pressure-resistant container 310 flows through the pressure-resistant container 310 and is exhausted outside the pressure-resistant container 310 through the control valve 342 (S805).

When the amount of dry ice 350 that has precipitated on the surface of the coolant flow pipe 312 reaches a predetermined amount (S806: YES), the control valves 341, 342 are closed to close the pressure-resistant container 310 air-tightly (S807). Also, the control valve 344 is closed to stop the flow of coolant (liquid nitrogen) through the coolant flow pipe 312 (S808). Whether the amount of dry ice 350 that has precipitated has reached a predetermined amount is determined by, for example, examining visually the inside of the pressure-resistant container 310 through the small window, or according to whether a predetermined period of time has elapsed.

Next, the control valve 345 is opened for the heat medium to flow through the heat transfer pipe 313 (S809) to raise the temperature inside the pressure-resistant container 310. As the temperature inside the pressure-resistant container 310 increases, the dry ice 350 that has precipitated on the surface of the coolant flow pipe 312 starts to vaporize (sublimate) (S810). Meanwhile, by the dry ice 350 vaporizing, the pressure inside the pressure-resistant container 310 increases. As shown in FIG. 9, the triple point of carbon dioxide is at 5.11 atm and −56.6° C. Hence, when due to the dry ice 350 vaporizing, the temperature and pressure inside the pressure-resistant container 310 become higher than those of the triple point, part of carbon dioxide in the pressure-resistant container 310 starts to liquefy and the liquid carbon dioxide produced by liquefying starts accumulating at the bottom of the pressure-resistant container 310 (S811).

Then, when the dry ice 350 that has precipitated on the surface of the coolant flow pipe 312 completely vaporizes or liquefies (S811: YES), the control valve 343 is opened. Thereby, liquid carbon dioxide that has accumulated at the bottom of the pressure-resistant container 310 is discharged by the pressure inside the pressure-resistant container 310 outside the pressure-resistant container 310 through the liquid outlet 323 (S813). Whether the dry ice 350 has completely vaporized or liquefied is determined by, for example, examining visually the inside of the pressure-resistant container 310 through the small window, or according to whether a predetermined period of time has elapsed. By keeping the inside of the liquid exhaust pipe 33 connected to the liquid outlet 323 at such a temperature and pressure as to keep carbon dioxide liquid, carbon dioxide can be discharged outside the pressure-resistant container 310 with being kept liquid.

As described above, with the carbon dioxide separator 30 of the present embodiment, carbon dioxide contained in gas can be separated efficiently. With the control valve 344 and the control valve 345 of the heat transfer pipe 313 closed, by repeating the processes of S801 and later, carbon dioxide can be separated continuously from exhaust gas being continuously introduced from the reversible heat exchanger 23 (S814: NO).

With the carbon dioxide separator 30, carbon dioxide can be solidified or liquefied inside the same pressure-resistant container 310. Furthermore, the carbon dioxide separator 30 is simple in configuration as described above, and thus can be implemented at low cost. Yet further, since the carbon dioxide separator 30 has the dry ice 350 precipitate on the outside of the heat transfer pipe (coolant flow pipe 312), the inside path of the heat transfer pipe 313 will not be blocked, and thus it is easy to carry out continuous or automatic operation. Still further, without using a special liquefying device, carbon dioxide can be discharged in the form of liquid, which is convenient for transport and storage.

The control valves 341 to 345 may be, for example, electromagnetic valves, which are connected to a computer via control lines to control, and be remotely controlled by hardware of the computer and control software that runs on the hardware. Moreover, all or part of the above processes may be arranged to be executed automatically based on the output values of the various sensors.

### Fourth Embodiment

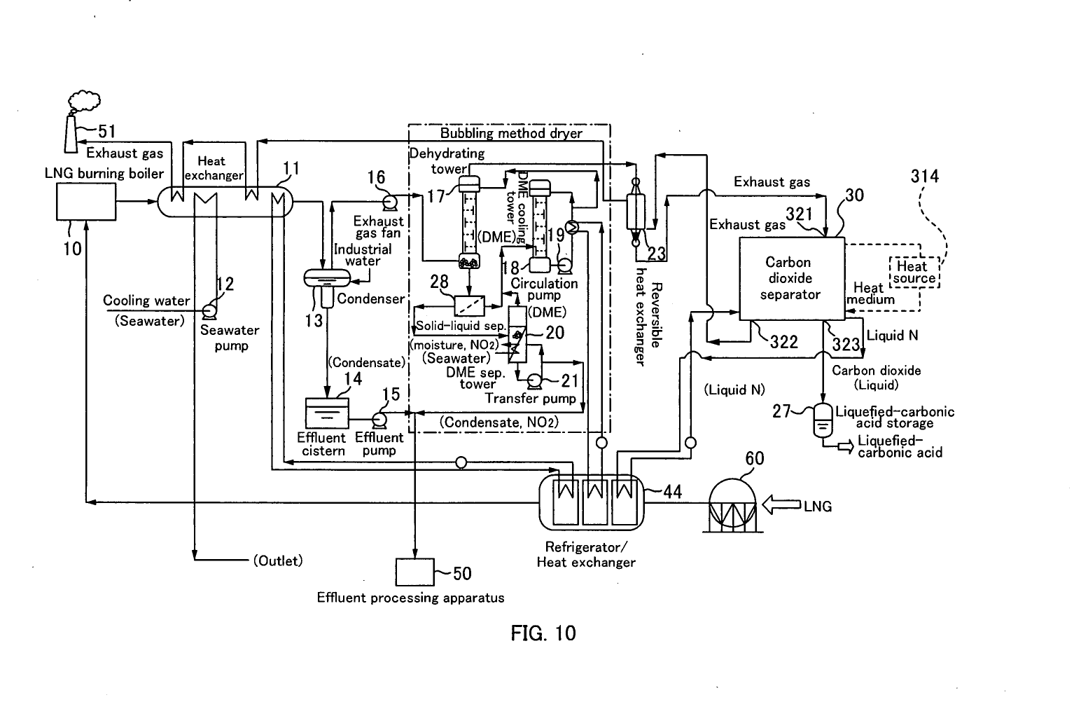

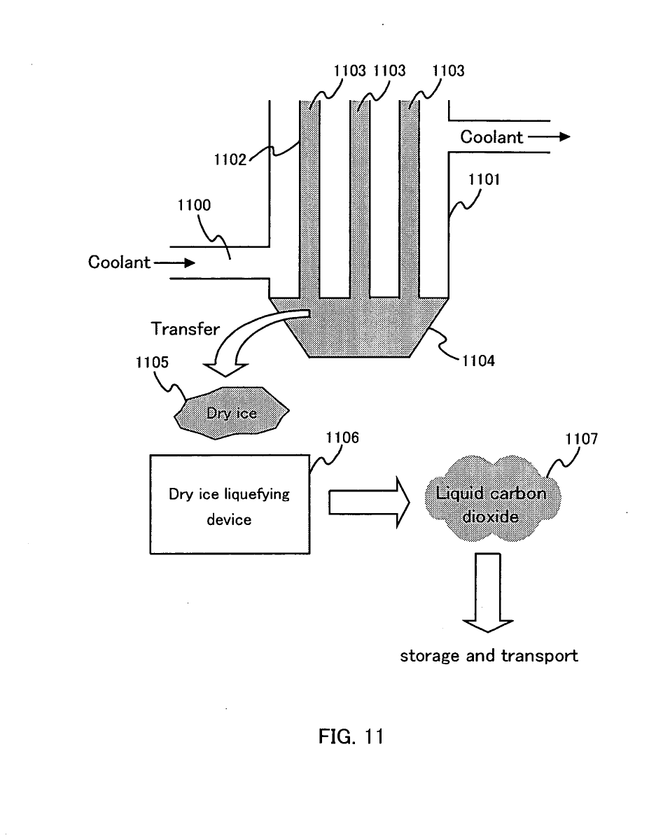

FIG. 10 shows the schematic configuration of an exhaust gas processing system according to a fourth embodiment of the present invention. This exhaust gas processing system can efficiently retrieves carbon dioxide (CO₂) contained in exhaust gas including toxic gas components such as nitrogen oxides, exhausted from an exhaust gas source 10 such as an LNG burning boiler of a generating station, chemical plant, etc., while efficiently removing moisture and toxic gas components contained in the exhaust gas.

In this exhaust gas processing system, in its preprocess, exhaust gas including toxic gas components such as nitrogen oxides, exhausted from the exhaust gas source 10 is introduced into industrial water contained in a heat exchanger 11 and a condenser 13 and thereby cooled to about room temperature. Then, in a first process, the exhaust gas cooled to about room temperature is cooled in a dehydrating tower 17 to such a first temperature as not to solidify carbon dioxide, and thereby moisture and nitrogen oxides contained in the exhaust gas are liquefied or solidified and thus separated from the exhaust gas. Further, in a second process, the exhaust gas has moisture and nitrogen oxides separated therefrom is introduced into the carbon dioxide separator 30, in which carbon dioxide contained in the exhaust gas is cooled and solidified to be separated. The separated carbon dioxide is liquefied and discharged.

Next, specific processes of the exhaust gas processing system of the present embodiment will be described sequentially. First, in the preprocess, exhaust gas including toxic gas components such as nitrogen oxides, exhausted from the exhaust gas source 10 such as an LNG burning boiler is introduced into the heat exchanger 11, in which seawater (at, e.g., 25° C.) supplied via a seawater pump 12 and a coolant such as ethylene glycol circulated from a refrigerator 40 are introduced. The exhaust gas (at, e.g., 55° C.) introduced from the exhaust gas source 10 passes through the heat exchanger 11 and thereby is cooled by the seawater and the coolant to about room temperature.

The cooled exhaust gas is introduced into the condenser 13, and then introduced into industrial water contained in the condenser 13. Thereby, moisture, the toxic gas components, dust, and the like contained in the exhaust gas are removed. The liquefied water including the moisture, the toxic gas components, the dust, and the like removed from the exhaust gas is temporarily stored in an effluent cistern 14 and then introduced into an effluent processing apparatus 50 by an effluent pump 15. The exhaust gas having passed through the condenser 13 is then introduced by an exhaust gas fan 16 into the dehydrating tower 17. Note that heat exchange with the industrial water in the condenser 13 cools the exhaust gas from about room temperature to 5° C.

In the dehydrating tower 17, the exhaust gas is further dehydrated and has the toxic gas components removed. By removing moisture contained in the exhaust gas, carbon dioxide contained in the exhaust gas can be retrieved efficiently in the retrieval process that is executed later.

The exhaust gas is introduced into the dehydrating tower 17 at its lower end. The exhaust gas (at, e.g., 5° C.) introduced in the dehydrating tower 17 is made to flow through DME (at, e.g., −90° C.) with which the dehydrating tower 17 is filled, according to a bubbling method. Then, the exhaust gas is cooled through heat exchange with the DME to a cooling temperature, at which moisture and toxic gas components contained in the exhaust gas are liquefied or solidified while carbon dioxide is not solidified. Although the moisture and nitrogen dioxide are liquefied or solidified and separated from the exhaust gas, the carbon dioxide remains gas in the exhaust gas. Exhaust gas including carbon dioxide that has risen to the upper portion of the dehydrating tower 17 is introduced into a reversible heat exchanger 23.

The DME is supplied circularly from a DME cooling tower 18, which cools the DME, to the dehydrating tower 17. Through the DME cooling tower 18, coolant (liquid nitrogen) cooled by the refrigerator/heat exchanger 44 is circulated by a circulation pump 19. The DME is cooled through heat exchange with the coolant.

The DME that has had the exhaust gas introduced into it in the dehydrating tower 17 is introduced into a solid-liquid separation tower 28. Note that in this stage, the DME and substances into which moisture and the toxic gas components have solidified are in a sherbet state (slurry). The solid-liquid separation tower 28 separates the DME and the solidified substances. The DME separated by the solid-liquid separation tower 28 is introduced into a DME separation tower 20 for reuse. The DME introduced into the DME separation tower 20 has some of moisture and the toxic gas components remaining.

The DME from the dehydrating tower 17 introduced in the DME separation tower 20 is raised in temperature (to, e.g., 5° C.) through indirect heat exchange with seawater. At this temperature, the moisture and the toxic gas components are liquid or solid, while the DME is gas. Hence, the DME gas rises to the upper portion of the DME separation tower 20, thereby being separated from the other components. The DME that has risen to the upper portion of the DME separation tower 20 is retrieved from there and introduced into the DME cooling tower 18, and again introduced into the dehydrating tower 17. In this way, the DME is reused circularly. As such, by reusing the DME as coolant circularly, the exhaust gas processing system of the embodiment as a whole is operated to use the coolant efficiently. Meanwhile, the liquid or solid moisture and toxic gas components that remain in the DME separation tower 20 are introduced into the effluent processing apparatus 50.

Exhaust gas introduced from the dehydrating tower 17 into a reversible heat exchanger 23 is cooled there and then introduced into the carbon dioxide separator 30. The carbon dioxide separator 30 separates carbon dioxide from the exhaust gas and liquefies and discharges the separated carbon dioxide. The detailed configuration and functions of the carbon dioxide separator 30 is the same as described previously.

The discharged liquefied carbon dioxide is transferred to and stored in a liquefied-carbonic acid storage 27. Meanwhile, the exhaust gas that has had carbon dioxide separated therefrom in the carbon dioxide separator 30 is introduced into the reversible heat exchanger 23 and used as coolant, and then is introduced into the heat exchanger 11. After being used as coolant in the heat exchanger 11, the exhaust gas is discharged into the atmosphere outside the system through the smokestack 51. The discharging into the atmosphere is to let part of the exhaust gas out to lessen the accumulation of the exhaust gas in the system. Therefore, carbon dioxide in the exhaust gas discharged is very low in concentration.

Here, the refrigerator/heat exchanger 44 cools ethylene glycol that is circulated through the heat exchanger 11 and coolant such as liquid nitrogen that is circulated through the DME cooling tower 18, the dry ice sublimator 24, etc., by use of the heat of vaporization of LNG. In, e.g., a generating station using LNG as gas fuel, the LNG is transported in a liquid state (at a temperature of, e.g., −150 to −165° C.) and stored in an LNG tank or the like. When the LNG is used as gas fuel, the LNG obtains the heat of vaporization from the atmosphere or seawater to rise in temperature and vaporize, while the refrigerator/heat exchanger 44 cools coolants such as ethylene glycol and liquid nitrogen by using this heat of vaporization. That is, exhaust gas or coolant is cooled by using the heat of vaporization that is produced when the LNG is used as gas fuel. Technology of solidifying and separating carbon dioxide contained in exhaust gas by using the heat of vaporization of LNG is disclosed in, e.g., Japanese Patent Application Laid-Open Publication No. H08-12314 or the like.

As described above, the exhaust gas processing system of the present embodiment can efficiently remove moisture and toxic gas components from exhaust gas including the toxic gas components such as nitrogen oxides, exhausted from an LNG burning boiler or the like, and further can efficiently retrieve carbon dioxide from the exhaust gas.

Although the case has been described above where the toxic gas component to be removed from exhaust gas is nitrogen dioxide, the same scheme as the present embodiment can be applied to other toxic gas components such as carbon monoxide, other nitrogen oxides (NOₓ) such as nitrogen monoxide, and halogen compounds such as hydrogen fluoride by selecting as the coolants appropriately.

The control valves 341 to 345 may be, for example, electromagnetic valves, which are connected to a computer via control lines to control, and remotely controlled by hardware of the computer and control software that runs on the hardware. Moreover, all or part of the above processes may be arranged to be executed automatically based on the output values of the various sensors.

Although the embodiments of the present invention have been described, the above embodiments are provided to facilitate the understanding of the present invention and not intended to limit the present invention. It should be understood that various changes and alterations can be made therein without departing from the spirit and scope of the invention and that the present invention includes its equivalents.

What is claimed is:

1. An exhaust gas processing method characterized by comprising:
a first process of making exhaust gas flow through coolant to cool it to such a first temperature as to liquefy or solidify nitrogen oxides without solidifying carbon dioxide, thereby liquefying or solidifying nitrogen oxides as toxic gas components contained in the exhaust gas to separate them from the exhaust gas; and
a second process of cooling the exhaust gas to such a second temperature as to solidify carbon dioxide, thereby solidifying carbon dioxide contained in the exhaust gas to separate it from the exhaust gas.

2. The exhaust gas processing method according to claim 1, characterized by comprising:
a first process of making exhaust gas flow through coolant to cool it to such a first temperature as to liquefy or solidify nitrogen oxides and sulfur oxides without solidifying carbon dioxide, thereby liquefying or solidifying nitrogen oxides and sulfur oxides as toxic gas components contained in the exhaust gas to separate them from the exhaust gas; and
a second process of cooling the exhaust gas to such a second temperature as to solidify carbon dioxide, thereby solidifying carbon dioxide contained in the exhaust gas to separate it from the exhaust gas.

3. The exhaust gas processing method according to claim 2, characterized by comprising:
a process of raising in temperature the toxic gas components separated from the exhaust gas by the first process to such a temperature as to vaporize the coolant but not the toxic gas components, thereby separating the toxic gas components and the coolant.

4. The exhaust gas processing method according to claim 3, characterized by comprising:
a process of circulating the coolant separated from the toxic gas components as the coolant through which the exhaust gas is made to flow.

5. The exhaust gas processing method according to any one of claims 2 to 4, characterized by comprising:
a process of raising in temperature the toxic gas components separated from the exhaust gas by the first process to such a temperature as to vaporize sulfur oxides but not nitrogen oxides, thereby separating the sulfur oxides and nitrogen oxides included in the toxic gas components.

6. The exhaust gas processing method according to any one of claims 2 to 5, characterized in that the coolant includes any one of dimethyl ether, methanol, ethanol, toluene, and ethyl benzene.

7. The exhaust gas processing method according to any one of claims 2 to 6, characterized in that the first process includes a process of separating moisture contained in the exhaust gas from the exhaust gas.

8. The exhaust gas processing method according to any one of claims 2 to 7, characterized in that the second process includes a process of liquefying the solidified carbon dioxide (dry ice).

9. The exhaust gas processing method according to any one of claims 2 to 8, characterized in that a preprocess of removing moisture, toxic gas components, and dust contained in the exhaust gas through heat exchange with water after the exhaust gas is cooled to about room temperature is executed before the first process.

10. An exhaust gas processing system characterized by comprising:
a first apparatus which performs a process of making exhaust gas flow through coolant to cool it to such a first temperature as to liquefy or solidify nitrogen oxides without solidifying carbon dioxide, thereby liquefying or solidifying nitrogen oxides as toxic gas components contained in the exhaust gas to separate them from the exhaust gas; and
a second apparatus which performs a process of cooling the exhaust gas to such a second temperature as to solidify carbon dioxide, thereby solidifying carbon dioxide contained in the exhaust gas to separate it from the exhaust gas.

11. The exhaust gas processing system according to claim 10, characterized by comprising:
a first apparatus which performs a process of making exhaust gas flow through coolant to cool it to such a first temperature as to liquefy or solidify nitrogen oxides and sulfur oxides without solidifying carbon dioxide, thereby liquefying or solidifying nitrogen oxides and sulfur oxides as toxic gas components contained in the exhaust gas to separate them from the exhaust gas; and
a second apparatus which performs a process of cooling the exhaust gas to such a second temperature as to solidify carbon dioxide, thereby solidifying carbon dioxide contained in the exhaust gas to separate it from the exhaust gas.

12. The exhaust gas processing system according to claim 11, characterized by comprising:
an apparatus which raises in temperature the toxic gas components separated from the exhaust gas by the first apparatus to such a temperature as to vaporize the coolant, which is mixed with the toxic gas components, but not the toxic gas components, thereby separating the toxic gas components and the coolant.

13. The exhaust gas processing system according to claim 11, characterized by comprising:
an apparatus which circulates the coolant separated from the toxic gas components as the coolant through which the exhaust gas is made to flow.

14. The exhaust gas processing system according to any one of claims 11 to 13, characterized by comprising:
an apparatus which raises in temperature the toxic gas components separated from the exhaust gas by the first apparatus to such a temperature as to vaporize sulfur oxides but not nitrogen oxides, thereby separating the sulfur oxides and nitrogen oxides included in the toxic gas components.

15. The exhaust gas processing system according to any one of claims 11 to 14, characterized in that the coolant includes any one of dimethyl ether, methanol, ethanol, toluene, and ethyl benzene.

16. The exhaust gas processing system according to any one of claims 11 to 15, characterized in that the first apparatus comprises an apparatus which separates moisture contained in the exhaust gas from the exhaust gas.

17. The exhaust gas processing system according to any one of claims 11 to 16, characterized in that the second apparatus comprises an apparatus which liquefies the solidified carbon dioxide (dry ice).

18. The exhaust gas processing system according to any one of claims 11 to 17, characterized by comprising:
an apparatus which performs a preprocess of removing moisture, toxic gas components, and dust contained in the exhaust gas through heat exchange with water after the exhaust gas is cooled to about room temperature, before the process to be performed by the first apparatus.

19. An exhaust gas processing method characterized by comprising:
a first process of making exhaust gas exhausted from an LNG burning boiler flow through coolant to cool it to such a first temperature as to liquefy or solidify nitrogen oxides without solidifying carbon dioxide, thereby liquefying or solidifying nitrogen oxides as toxic gas components contained in the exhaust gas to separate them from the exhaust gas; and
a second process of cooling the exhaust gas to such a second temperature as to solidify carbon dioxide, thereby solidifying carbon dioxide contained in the exhaust gas to separate it from the exhaust gas.

20. The exhaust gas processing method according to claim 19, characterized by comprising:
a process of introducing the nitrogen oxides solidified by the first process into a solid-liquid separator, thus separating the nitrogen oxides and the coolant.

21. The exhaust gas processing method according to claim 20, characterized by comprising:
a process of raising in temperature the liquid separated by the solid-liquid separator to such a temperature as to vaporize the coolant but not the toxic gas components, thereby separating the coolant.

22. The exhaust gas processing method according to claim 21, characterized by comprising:
a process of circulating the coolant separated from the liquid as the coolant through which the exhaust gas is made to flow.

23. The exhaust gas processing method according to any one of claims 19 to 22, characterized in that the coolant includes any one of dimethyl ether, methanol, ethanol, toluene, and ethyl benzene.

24. The exhaust gas processing method according to any one of claims 19 to 23, characterized in that the first process includes a process of separating moisture contained in the exhaust gas from the exhaust gas.

25. The exhaust gas processing method according to any one of claims 19 to 24, characterized in that the second process includes a process of liquefying the solidified carbon dioxide (dry ice).

26. The exhaust gas processing method according to any one of claims 19 to 25, characterized in that a preprocess of removing moisture and toxic gas components contained in the exhaust gas through heat exchange with water after the exhaust gas is cooled to about room temperature is executed before the first process.

27. The exhaust gas processing method according to any one of claims 19 to 26, characterized in that the exhaust gas or the coolant of at least one of the first and second processes is cooled due to the heat of vaporization that is produced when LNG is used as gas fuel.

28. An exhaust gas processing system characterized by comprising:
a first apparatus which performs a process of making exhaust gas exhausted from an LNG burning boiler flow through coolant to cool it to such a first temperature as to liquidize or solidify nitrogen oxides without solidifying carbon dioxide, thereby liquidizing or solidifying nitrogen oxides as toxic gas components contained in the exhaust gas to separate them from the exhaust gas; and
a second apparatus which performs a process of cooling the exhaust gas to such a second temperature as to solidify carbon dioxide, thereby solidifying carbon dioxide contained in the exhaust gas to separate it from the exhaust gas.

29. The exhaust gas processing system according to claim 28, characterized by comprising:
an apparatus which introduces the nitrogen oxides solidified by the first apparatus into a solid-liquid separator, thus separating the nitrogen oxides and the coolant.

30. The exhaust gas processing system according to claim 29, characterized by comprising:
an apparatus which raises in temperature the liquid separated by the solid-liquid separator to such a temperature as to vaporize the coolant but not the toxic gas components, thereby separating the coolant.

31. The exhaust gas processing system according to claim 30, characterized by comprising:
an apparatus which circulates the coolant separated from the liquid as the coolant through which the exhaust gas is made to flow.

32. The exhaust gas processing system according to any one of claims 28 to 31, characterized in that the coolant includes any one of dimethyl ether, methanol, ethanol, toluene, and ethyl benzene.

33. The exhaust gas processing system according to any one of claims 28 to 32, characterized in that the first apparatus comprises an apparatus which separates moisture contained in the exhaust gas from the exhaust gas.

34. The exhaust gas processing system according to any one of claims 28 to 33, characterized in that the second apparatus comprises an apparatus which liquefies the solidified carbon dioxide (dry ice).

35. The exhaust gas processing system according to any one of claims 28 to 34, characterized by comprising:
an apparatus which performs a preprocess of removing moisture and toxic gas components contained in the exhaust gas through heat exchange with water after the exhaust gas is cooled to about room temperature, before the process to be performed by the first apparatus.

36. The exhaust gas processing system according to any one of claims 28 to 35, characterized in that the exhaust gas or the coolant in at least one of the first and second apparatuses is cooled due to the heat of vaporization that is produced when LNG is used as gas fuel.

37. An exhaust gas processing system characterized by comprising:
a first apparatus which makes exhaust gas flow through coolant to cool it to such a temperature as to liquefy or solidify nitrogen oxides and sulfur oxides without solidifying carbon dioxide, thereby liquefying or solidifying nitrogen oxides and sulfur oxides as toxic gas components contained in the exhaust gas to separate them from the exhaust gas; and
a second apparatus which makes the exhaust gas having had the nitrogen oxides and sulfur oxides removed flow through a pressure-resistant container to cool and solidify carbon dioxide, closes the pressure-resistant container air-tightly, raises in temperature the solidified carbon dioxide to vaporize, liquefies the carbon dioxide by pressure increase due to the vaporization of the carbon dioxide in the pressure-resistant container, and discharges the liquefied carbon dioxide outside the pressure-resistant container.

38. The exhaust gas processing system according to claim 37, characterized by comprising:
an apparatus which raises in temperature the toxic gas components separated from the exhaust gas by the first apparatus to such a temperature as to vaporize the coolant, which is mixed with the toxic gas components, but not the toxic gas components, thereby separating the toxic gas components and the coolant.

39. The exhaust gas processing system according to claim 37 or 38, characterized by comprising:
an apparatus which raises in temperature the toxic gas components separated from the exhaust gas by the first apparatus to such a temperature as to vaporize sulfur oxides but not nitrogen oxides, thereby separating the sulfur oxides and nitrogen oxides included in the toxic gas components.

40. An exhaust gas processing system characterized by comprising:
a first apparatus which performs a process of making exhaust gas exhausted from an LNG burning boiler flow through coolant to cool it to such a first temperature as to liquefy or solidify nitrogen oxides without solidifying carbon dioxide, thereby liquefying or solidifying nitrogen oxides as toxic gas components contained in the exhaust gas to separate them from the exhaust gas; and
a second apparatus which makes the exhaust gas having had the nitrogen oxides removed flow through a pressure-resistant container to cool and solidify carbon dioxide, closes the pressure-resistant container air-tightly, raises in temperature the solidified carbon dioxide to vaporize, liquefies the carbon dioxide by pressure increase due to the vaporization of the carbon dioxide in the pressure-resistant container, and discharges the liquefied carbon dioxide outside the pressure-resistant container.

41. The exhaust gas processing system according to claim 40, characterized by comprising:
an apparatus which introduces the nitrogen oxides solidified by the first process into a solid-liquid separator, thus separating the nitrogen oxides and the coolant.

42. The exhaust gas processing system according to claim 41, characterized by comprising:
an apparatus which raises in temperature the liquid separated by the solid-liquid separator to such a temperature as to vaporize the coolant but not the toxic gas components, thereby separating the coolant.

43. The exhaust gas processing system according to any one of claims 37 to 42, characterized in that the coolant includes any one of dimethyl ether, methanol, ethanol, toluene, and ethyl benzene.

44. The exhaust gas processing system according to any one of claims 37 to 43, characterized in that the cooling and solidifying of the carbon dioxide by the second apparatus is performed by causing gas containing the carbon dioxide to contact the outside of a coolant flow pipe provided in the pressure-resistant container through which coolant flows.

45. The exhaust gas processing system according to any one of claims 37 to 44, characterized in that the coolant flow pipe is arranged to be serpentine.

46. A method of separating carbon dioxide, characterized by comprising:
making gas containing carbon dioxide flow through a pressure-resistant container to cool and solidify the carbon dioxide;
closing the pressure-resistant container air-tightly;
raising in temperature the solidified carbon dioxide to vaporize;
liquefying the carbon dioxide by pressure increase due to the vaporization of the carbon dioxide in the pressure-resistant container; and
discharging the liquefied carbon dioxide outside the pressure-resistant container.

47. The method of separating carbon dioxide according to claim 46, characterized in that the cooling and solidifying is performed by causing gas containing the carbon dioxide to contact the outside of a coolant flow pipe provided in the pressure-resistant container through which coolant flows.

48. The method of separating carbon dioxide according to claim 47, characterized in that the coolant flow pipe is arranged to be serpentine.

49. The method of separating carbon dioxide according to claim 46, characterized in that the raising in temperature of the solidified carbon dioxide is performed by a heat transfer pipe or an electric heater provided in the pressure-resistant container.

50. The method of separating carbon dioxide according to claim 46, characterized in that the pressure-resistant container comprising:
a gas inlet which lets gas containing the carbon dioxide flow into the pressure-resistant container;
a gas outlet through which gas in the pressure-resistant container is discharged outside the pressure-resistant container; and
a liquid outlet through which the liquefied carbon dioxide is discharged outside the pressure-resistant container.

51. The method of separating carbon dioxide according to claim 46 or 47, characterized in that the gas includes nitrogen oxides or sulfur oxides.

52. A method of separating carbon dioxide which uses a pressure-resistant container having a gas inlet to let gas flow into it, a gas outlet to let gas therein be discharged, and a liquid outlet to let liquid therein be discharged; a cooler provided in the pressure-resistant container; and a heat transfer device to raise in temperature the inside of the pressure-resistant container, characterized by comprising:
letting gas containing carbon dioxide flow into the pressure-resistant container through the gas inlet;
causing the gas to contact the cooler, thereby cooling and solidifying the carbon dioxide;
closing the gas inlet and gas outlet, thereby closing the pressure-resistant container air-tightly;
raising in temperature the solidified carbon dioxide to vaporize with use of the heat transfer device;
liquefying the carbon dioxide by pressure increase due to the vaporization of the carbon dioxide in the pressure-resistant container; and
discharging the liquefied carbon dioxide outside the pressure-resistant container through the liquid outlet.

53. An apparatus of separating carbon dioxide characterized by comprising:
a pressure-resistant container having a gas inlet to let gas flow into it, a gas outlet to let gas therein be discharged, a liquid outlet to let liquid therein be discharged, a control valve to control the amount of gas flowing in through the gas inlet, a control valve to control the amount of gas being discharged through the gas outlet, and a control valve to control the amount of liquid being discharged through the liquid outlet;
a cooler provided in the pressure-resistant container; and
a heat transfer device that raises in temperature the inside of the pressure-resistant container.
